(19) United States
(12) Patent Application Publication
(10) Pub. No.: US 2024/0193574 A1
(43) Pub. Date: Jun. 13, 2024

(54) ONE OR MORE CAMERAS FOR USE IN AN AUTONOMOUS CHECKOUT IN A CASHIER-LESS SHOPPING STORE AND OTHERWISE

(71) Applicant: Standard Cognition, Corp., San Francisco, CA (US)

(72) Inventors: Kunal KISHORE BAJAJ, Fremont, CA (US); Peter RENNERT, Dunblane, Scotland, UK (GB); Dhananjay SINGH, San Francisco, CA (US); Shelby Traci FARNSWORTH, Costa Mesa, CA (US); Jordan FISHER, San Francisco, CA (US); Sameer QURESHI, Sunnyvale, CA (US); Ozgur YILMAZ, Adana (TR); Luca LULLERI, Milano (IT); Atul DHINGRA, Sunnyvale, CA (US)

(73) Assignee: Standard Cognition, Corp., San Francisco, CA (US)

(21) Appl. No.: 18/539,228

(22) Filed: Dec. 13, 2023

Related U.S. Application Data
(60) Provisional application No. 63/432,333, filed on Dec. 13, 2022.

(51) Int. Cl. G06Q 20/20; G06V 10/82; G06V 20/52; H04N 7/18

(52) U.S. Cl. CPC G06Q 20/208; G06Q 20/203; G06V 10/82; G06V 20/52; H04N 7/181

(57) ABSTRACT

The technology disclosed relates to detecting events and identifying items in detected events in an area of real space in a shopping store including a cashier-less checkout system. The system comprises an image sensor assembly comprising at least one narrow field of view (NFOV) image sensor and at least one wide field of view (WFOV) image sensor. The at least one NFOV image sensor produces raw image data of first-resolution frames of a corresponding field of view and the at least one WFOV image sensor produces raw image data of second-resolution frames of a corresponding field of view. The system comprises logic to provide at least a portion of a sequence of second-resolution frames produced by the WFOV image sensor to an event detection device configured to detect (i) a particular event and (ii) a location of the particular event in the area of real space.

### PRIORITY APPLICATION

This application claims the benefit of U.S. Provisional Patent Application No. 63/432,333 (Attorney Docket No. STCG 1036-1) filed 13 Dec. 2022, which application is incorporated herein by reference.

### BACKGROUND

### Field

The technology disclosed relates to one or more cameras for monitoring areas of real space. More specifically, the technology disclosed relates to one or more cameras for use in an autonomous checkout in a cashier-less or hybrid (with minimal cashier support) shopping store.

### Description of Related Art

Cashier-less shopping stores or shopping stores with self-service checkout provide convenience to shoppers as they can enter the store, take items from shelves, and walk out of the shopping store. In some cases, the shoppers may have to check-in and/or check-out using a kiosk. The cashier-less shopping store can include multiple cameras fixed to the ceiling. The cameras can capture images of the shoppers. The images can then be used to identify the actions performed by the shoppers and the items taken by the shoppers during their trip to the shopping store. However, installing the cameras in the shopping store can be challenging as several constraints need to be met. Similarly, installation of a large number of cameras can take considerable effort, thus increasing the installation costs. Installation can also take a considerable amount of time, thus causing disruptions to operations of shopping stores in which the cameras are installed. The cameras can capture a large amount of data (e.g., images, videos, etc.). It can be challenging to process such a large amount of data due to bandwidth, storage and processing limitations.

It is desirable to provide a system that can be easily installed in the shopping store without requiring considerable effort and/or installation time and that can efficiently process large amounts of data captured by sensors in the shopping store.

### SUMMARY

A camera system and method for operating the camera system are disclosed. The camera system includes logic to detect events and identify items in detected events in an area of real space in a shopping store including a cashier-less checkout system. The camera system comprises an image sensor assembly comprising at least one narrow field of view (NFOV) image sensor and at least one wide field of view (WFOV) image sensor. The at least one NFOV image sensor can produce raw image data of first-resolution frames of a corresponding field of view in the real space and the at least one WFOV image sensor can produce raw image data of second-resolution frames of a corresponding field of view in the real space. The camera system comprises logic to provide at least a portion of a sequence of second-resolution frames produced by the WFOV image sensor to an event detection device configured to detect (i) a particular event and (ii) a location of the particular event in the area of real space. The camera system comprises logic to send at least one frame in the sequence of first-resolution frames to an item detection device configured to identify a particular item in the particular event detected by the event detection device.

The camera system further comprises logic to send the portion of the second-resolution frames to a subject tracking device configured to identify a subject using at least one image frame from the portion of the second-resolution frames.

The image sensor assembly can comprise at least two or more NFOV image sensors. It is understood that the camera assembly can have four, five, six, seven, eight or more NFOV image sensors. The camera assembly can have up to twenty NFOV image sensors.

The camera system further comprises logic to provide the location at which the particular event is detected to a sensor selection device to select a sequence of the first-resolution frames provided by a NFOV image sensor by matching the location in the area of real space to the corresponding field of view of the NFOV image sensor.

The camera system further comprises logic to operate the NFOV image sensors in a round robin manner, turning on a NFOV image sensor for a pre-determined time period and turning off the remaining NFOV image sensors to collect the raw image data from the turned on NFOV image sensor. The camera system comprises logic to provide the raw image data collected from the turned on NFOV image sensor to an image processing device configured to generate a sequence of first-resolution frames corresponding to the turned on NFOV image sensor.

In one implementation, the camera system further comprises a memory storing the raw image data produced by the NFOV image sensors. The camera system comprises logic to access the raw image data produced by the NFOV sensors and stored in the memory in a round robin manner to collect raw image data from at least one NFOV image sensor. The camera system comprises logic to provide the raw image data collected from the least one NFOV image sensor to an image processing device configured to generate the sequence of first-resolution frames corresponding to the at least one NFOV image sensor.

In one implementation, the camera system further comprises logic to store the first-resolution frames and the second resolution frames in a storage device. The camera system comprises logic to access the storage device to retrieve a set of frames from a particular sequence of first-resolution frames in dependence upon a signal received from a data processing device and logic to provide the retrieved set of frames to the data processing device for downstream data processing.

The first-resolution of images captured by the NFOV sensors can be higher than the second-resolution of images captured by the WFOV sensors.

The NFOV image sensor can be configured to output at least one frame per a pre-determined time period. The pre-determined time can be between twenty seconds and forty seconds. The pre-determined time can be between ten seconds and fifty seconds. The pre-determined time can be up to one minute.

The first resolution image frames can have an image resolution of 8,000 pixels by 6,000 pixels. The first resolution image frames can have an image resolution greater than 8,000 pixels by 6,000 pixels. The first resolution image frames can have an image resolution greater than 6,000 pixels by 4,000 pixels. The second-resolution frames can have an image resolution of at least 3,040 pixels by at least 3,040 pixels. The second resolution image frames can have an image resolution greater than 3,040 pixels by 3,0404 pixels and/or less than 3,040 pixels by 3,040 pixels.

In one implementation, the camera system can comprise logic to stream the first-resolution frames and the second resolution frames to a data processing device configured to process the first-resolution frames and the second-resolution frames and detect inventory events and identify items corresponding to the inventory events.

In one implementation, the camera system can further comprise logic to detect poses of subjects in the area of real space. The camera system can comprise logic to receive a portion of the second-resolution frames from the wide field of view sensor. The camera system can comprise logic to extract features from the portion of the second-resolution frames, wherein the features represent joints of a subject in the field of view of the WFOV image sensor. The camera system can comprise logic to provide the extracted features to a subject tracking device configured to identify a subject in the area of real space using the extracted feature.

In one implementation, the camera system further comprises logic to provide operation parameters of the NFOV image sensor and the WFOV image sensor to a telemetry device configured to generate a notification when the operation parameters of at least one of the NFOV image sensor and the WFOV image sensor is outside a desired range of operation parameters.

A method for operating a camera system to detect events and identify items in detected events in an area of real space in a shopping store including a cashier-less checkout system is also disclosed. The method includes features for the system described above. Computer program products which can be executed by the computer system are also described herein.

Other aspects and advantages of the present invention can be seen on review of the drawings, the detailed description and the claims, which follow.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The invention will be described with respect to specific embodiments thereof, and reference will be made to the drawings, which are not drawn to scale, and in which:

FIG. 1A illustrates an architectural level schematic of a system that includes a plurality of camera systems to track subjects, detect events and identify items related to detected events.

FIG. 1B presents a high-level architecture of the camera system including devices to process data captured by sensors.

FIG. 2 is an example camogram representing inventory items in an area of real space including example inventory item data.

FIG. 3 is a system including camera systems comprising image capturing sensors for tracking inventory items in an area of real space.

FIG. 4A is a side view of an aisle in a shopping store illustrating a subject, inventory display structures and a camera system arrangement in a shopping store.

FIG. 4B is a perspective view, illustrating a subject taking an item from a shelf in the inventory display structure in the area of real space.

FIG. 5A presents an example camera system comprising six narrow field of view (NFOV) sensors and one wide field of view (WFOV) sensor.

FIG. 5B presents another view of the camera system of FIG. 5A with six NFOV sensors and one WFOV sensor.

FIG. 5C presents an exploded view of the camera system showing different components of the camera system.

FIG. 6A presents an example of a camera system comprising eight NFOV sensors and two WFOV sensors.

FIG. 6B presents another view of the camera system of FIG. 6A comprising eight NFOV sensors and two WFOV sensors.

FIG. 6C presents two industrial designs for camera systems comprising a plurality of NFOV sensors and at least one WFOV sensor.

FIG. 6D presents an exploded view of a camera system with eight NFOV sensors and two WFOV sensors.

FIG. 7A presents a 5-MUX camera hardware topology in which image data from one NFOV sensor is selected for processing using five switches.

FIG. 7B presents a 3-MUX camera hardware topology in which image data from one NFOV sensor is selected for processing using three switches.

FIG. 7C presents a software architecture diagram presenting processing of raw image data captured by the sensors.

FIGS. 7D, 7E, 7F, 7G and 7H present thermal design and temperature contours of the camera system enclosure.

FIG. 8 is a camera and computer hardware arrangement configured for deploying the camera system of FIGS. 1A and 1B.

FIG. 9A illustrates various metrics that can be used for determining placement of the cameras and/or camera systems described herein.

FIG. 9B illustrates various configurations and scores for different implementations of the cameras and/or camera systems described herein.

FIG. 9C illustrates various configurations and scores for different implementations of the cameras and/or camera systems described herein.

FIG. 9D illustrates locations, fields of view and scores for various implementations of the cameras and/or camera systems described herein.

FIG. 9E illustrates locations, fields of view and scores for various implementations of the cameras and/or camera systems described herein.

FIG. 9F illustrates various configurations and scores for different implementations of the cameras and/or camera systems described herein.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown but is to be accorded the widest scope consistent with the principles and features disclosed herein. The camera system described herein can be implemented in any environment to identify and track individuals and items. Many of the examples described herein identify a cashier-less shopping environment, but use of the camera system is not limited to just a cashier-less shopping environment. For example, the camera system described herein can be used in any environment for monitoring of people (e.g., employees), animals, and items (e.g., products).

### System Overview

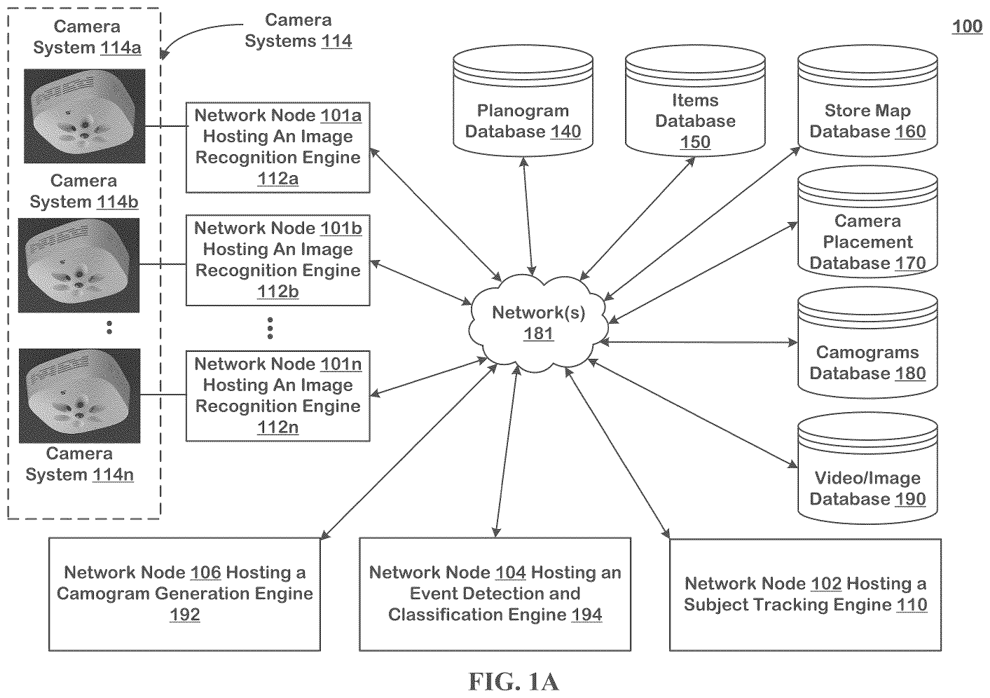

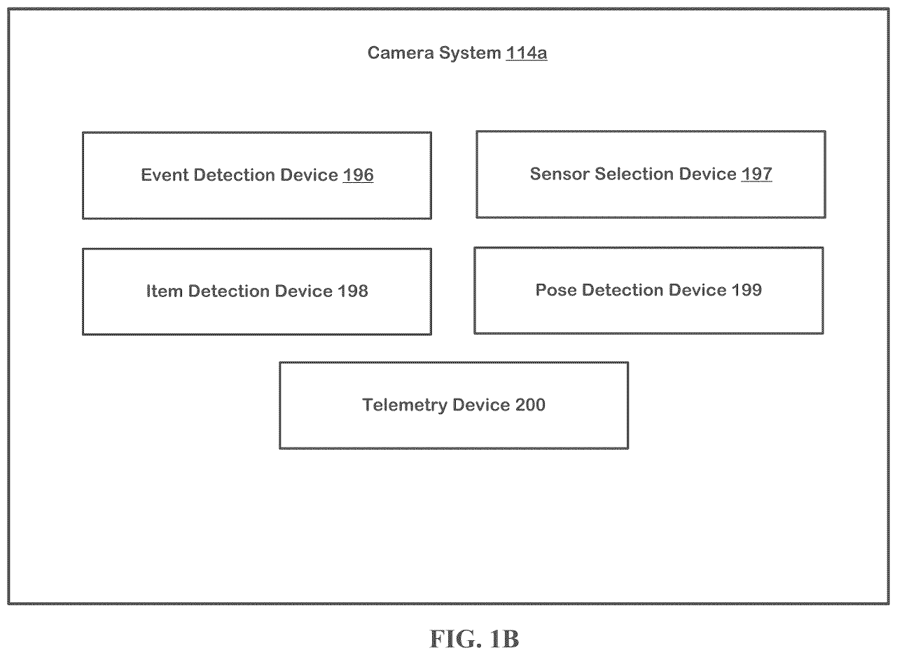

A system and various implementations of the subject technology are described with reference to FIGS. 1-9F. The system and processes are described with reference to FIG. 1A, an architectural level schematic of a system in accordance with an implementation. Because FIG. 1A is an architectural diagram, certain details are omitted to improve the clarity of the description.

The description of FIG. 1A is organized as follows. First, the elements of the system are described, followed by their interconnections. Then, the use of the elements in the system is described in greater detail.

FIG. 1A provides a block diagram level illustration of a system 100. The system 100 includes camera systems 114a, 114b and 114n, network nodes 101a, 101b, and 101n hosting image recognition engines 112a, 112b and 112n, a network node 102 hosting a subject tracking engine 110, a network node 104 hosting an event detection and classification engine 194, and a network node 106 hosting a camogram generation engine 192. The plurality of camera systems 114a, 114b and 114n are collectively referred to as camera systems 114. The network nodes 101a, 101b, 101n, 102, 104 and/or 106 can include or have access to memory supporting tracking of inventory items and tracking of subjects. The system 100 further includes, in this example, a planogram database 140, an items database 150, a store map database 160, a camera placement database 170, a camograms database 180, a video/image database 190, and a communication network or networks 181. Each of the planogram database 140, the items database 150, the store map database 160, the camera placement database 170, the camograms database 180, and the video/image database 190 can be stored in the memory that is accessible to the network nodes 101a, 101b, 101n, 102, 104 and/or 106. The network nodes 101a, 101b, 101n, 102, 104 and/or 106 can host only one image recognition engine, or several image recognition engines.

The system 100 can be deployed in a large variety of spaces to anonymously track subjects and detect events such as take, put, touch, etc. when subjects interact with items placed on shelves. The technology disclosed can be used for various applications in a variety of three-dimensional spaces. For example, the technology disclosed can be used in shopping stores, airports, gas stations, convenience stores, shopping malls, sports arenas, railway stations, libraries, etc. An implementation of the technology disclosed is provided with reference to cahier-less shopping stores and/or hybrid shopping stores also referred to as autonomous shopping stores. Cashier-less shopping stores may not have cashiers to process payments for shoppers. The shoppers may simply take items from shelves and walkout of the shopping store. In hybrid shopping stores, the shoppers may need to check-in or check-out from the store. The shoppers may use their mobile devices to perform check-in and/or check-out. Some shopping stores may provide kiosks to facilitate the shoppers to check-in or check-out. The technology disclosed includes logic to track subjects in the area of real space. The technology disclosed includes logic to detect interactions of subjects with items placed on shelves or other types of inventory display structures. The interactions can include actions such as taking items from shelves, putting items on shelves, touching items on shelves, rotating or moving items on shelves, etc. The shoppers may also just look at items they are interested in. In such cases, the technology disclosed can use gaze detection to determine items that the subject has looked at or viewed. The technology disclosed includes logic to process images captured by sensors (such as cameras) positioned in the area of real space.

The sensors (or cameras) can be fixed to ceiling or other types of fixed structures in the area of real space. Subject tracking can require generation of three-dimensional scenes for identifying and tracking subjects in the area of real space. Therefore, multiple cameras are needed to be installed that have overlapping fields of view. Similarly, identifying items can require high-resolution images that can require plurality of sensors that can capture images at a high-resolution. Therefore, even for a small area of real space, a large number (e.g., 3 or more) of individual cameras may be needed to provide coverage for all shelves and aisles in the shopping store. Installation of such large number of sensors (or cameras) can require considerable manual labor and can also disrupt operations of a shopping store for a longer duration of time while the cameras are being installed and calibrated. To reduce the installation effort and the downtime in operations of a shopping store, the technology disclosed provides a camera system that includes a camera assembly with a plurality of sensors (or cameras). The camera system can be easily installed in the area of real space. A few such camera systems can provide coverage similar to large number of individual sensors (or cameras) installed in the area of real space.

The technology disclosed also provides efficient processing of raw image data captured by cameras in the area of real space. Instead of sending the raw image data to a server that may be located offsite, the camera system includes logic to process the raw image data captured by cameras (or sensors) to generate image frames and to detect events and identify items related to events. The technology disclosed includes logic to use data from one or more camera systems to generate three dimensional scenes that can be used to identify subjects and track subjects in the area of real space.

The technology disclosed therefore, reduces the time, effort and cost of retrofitting a shopping store to transition the traditional shopping stores to autonomous shopping stores with cashier-less check-ins and/or cashier-less checkouts. Further, the technology disclosed can operate with limited network bandwidth as processing of raw image data can be performed locally on the camera system or on premises by combining data from a plurality of camera systems. This can reduce and/or eliminate the need to send large amounts of data off-site, so a server or to cloud-based storage. The technology disclosed also provides features to monitor the health of camera systems and to generate alerts when at least one operational parameter's value falls outside a desired range. The technology disclosed includes various industrial designs for camera systems including up to six or more narrow field of view (NFOV) cameras that can capture high-resolution images and one or more wide field of view (WFOV) cameras that can capture images at a lower resolution. Fewer than six NFOV cameras can also be implemented. The camera system can operate with fewer (such as one or more) image processing devices (such image signal processors or digital signal processors) to process raw image data captured by plurality of NFOV image sensors and at least one WFOV image sensor. The technology disclosed uses efficient use of resources for various tasks. For example, the camera system can operate the WFOV at higher frame rates and low image resolutions to identify subjects and detect events in the area of real space. When an event is detected, the information about the event such as location of the event, time of event, etc. can be used to select a NFOV image sensor for item detection. The camera system operates the NFOV sensors at low frame rates and high image resolutions. This allows the camera system to correctly detect and identify an item even when the item is small, and the lighting conditions are not optimal in the area of real space. Operating the NFOV sensors at lower frame rates conserves processes bandwidth and memory resources required for operating the camera system. The camera system can selectively turn on and turn off NFOV image sensors to capture images of items on shelves. The camera system can apply a round robin algorithm in which images captured by NFOV image sensors are processed one by one in a round robin manner for a pre-determined amount of time. Other non-round robin patterns and algorithms can be implemented.

When multiple NFOV image sensors are placed in a camera system, a large amount of raw image data can be captured by such sensors. An image signal processor (also referred to as a digital signal processor) placed in the camera system may not have the processing bandwidth to process all of the raw image data. The camera system, therefore, includes logic to process the raw image data captured by NFOV and/or WFOV image sensors in a round robin manner. One sensor is selected for a period of time to process the raw image data captured by the selected sensor. The image signal processor (ISP) can therefore process raw image data from the plurality of sensors, one by one, in a round robin manner. The raw image data captured by the plurality of NFOV sensors can be stored in memory buffers for respective NFOV image sensors. The round robin raw image data processing technique allows the camera system to operate with a minimum number of image signal processors (ISPs). In one implementation, the technology disclosed can operate with one ISP. In another implementation, the technology disclosed can operate with two ISPs. It is understood that more than two ISPs can also be used by the camera system. Further details of the camera system and the logic to operate the camera system are presented in the following sections.

The implementation described herein uses a plurality of camera systems 114a, 114b and 114n (collectively referred to as camera systems 114). The camera systems 114 comprise sensors (or cameras) in the visible range which can generate for example RGB color output images. In other embodiments, different kinds of sensors can be used to produce sequences of images (or representations). Examples of such sensors include, ultrasound sensors, thermal sensors, and/or Lidar, ultra-wideband sensors, depth sensors, etc., which are used to produce sequences of images (or representations) of corresponding fields of view in the real space. In one implementation, sensors can be used in addition to the camera systems 114. Multiple sensors can be synchronized in time with each other, so that frames are captured by the sensors at the same time, or close in time, and at the same frame capture rate (or different rates). All of the embodiments described herein can include sensors other than or in addition to the camera systems 114.

As used herein, a network node (e.g., network nodes 101a, 101b, 101n, 102, 104 and/or 106) is an addressable hardware device or virtual device that is attached to a network, and is capable of sending, receiving, or forwarding information over a communications channel to or from other network nodes. Examples of electronic devices which can be deployed as hardware network nodes include all varieties of computers, workstations, laptop computers, handheld computers, and smartphones. Network nodes can be implemented in a cloud-based server system and/or a local system. More than one virtual device configured as a network node can be implemented using a single physical device.

The databases 140, 150, 160, 170, 180, and 190 are stored on one or more non-transitory computer readable media. As used herein, no distinction is intended between whether a database is disposed “on” or “in” a computer readable medium. Additionally, as used herein, the term “database” does not necessarily imply any unity of structure. For example, two or more separate databases, when considered together, still constitute a “database” as that term is used herein. Thus in FIG. 1A, the databases 140, 150, 160, 170, 180, and 190 can be considered to be a single database. The system can include other databases such as a subject database storing data related to subjects in the area of real space, a shopping cart database storing logs of items or shopping carts of shoppers in the area of real space, etc.

Details of the various types of processing engines are presented below. These engines can comprise various devices that implement logic to perform operations to track subjects, detect and process inventory events and perform other operations related to a cashier-less store. A device (or an engine) described herein can include one or more processors. The ‘processor’ comprises hardware that runs a computer program code. Specifically, the specification teaches that the term ‘processor’ is synonymous with terms like controller and computer and should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry.

FIG. 1B presents components (such as devices) of the camera system 114a. Other camera systems (such as 114b and 114n) installed in the area of real space can have similar components or devices. The camera systems 114 can be used for detecting events and identifying items in detected events in the area of real space in a shopping store including a cashier-less checkout system. The camera system 114a can include a camera assembly comprising at least one narrow field of view (NFOV) image sensor and at least one wide field of view (WFOV) image sensor. In one implementation, the camera system can comprise a plurality of NFOV image sensors. Each of the NFOV image sensors can produce raw image data of high-resolution frames of a corresponding field of view in the real space. The one or more WFOV image sensors can produce raw image data of low-resolution frames of a corresponding field of view in the real space. The image sensor assembly can comprise six or more NFOV image sensors. The high-resolution frames can have an image resolution of at least 8,000 pixels by 6,000 pixels. It is understood that NFOV image sensors can capture images at a resolution lower than 8,000 pixels by 6,000 pixels or at a higher resolution than 8,000 pixels by 6,000 pixels. In one implementation, each of the NFOV image sensors is configured to output at least one frame every thirty seconds. It is understood that one or more NFOV image sensors can output more than one image frame per thirty seconds. The low-resolution frames from WFOV image sensor can have an image resolution of at least 3,040 pixels by 3,040 pixels. It is understood that WFOV image sensors can capture images at a resolution lower than 3,040 pixels by 3,040 pixels or at a higher resolution than 3,040 pixels by 3,040 pixels The sensor assembly can include one or more than one (such as two) WFOV image sensors.

As shown in FIG. 1B, the camera system 114a comprises an event detection device 196 configured to detect (i) a particular event and (ii) a location of the particular event in the area of real space. The event can include at least one of a put event, a take event and a touch event related to an item. The event detection device can receive at least a portion of a sequence of low-resolution frames produced by the WFOV image sensor to detect the event. The event detection device 196 can implement the same logic as implemented by the event detection and classification engine 194.

The camera system 114a comprises a sensor selection device 197 comprising logic to select a particular sensor from a plurality of NFOV sensors in the camera system. The selection can be based on a location of the detected event. The selection of a NFOV allows processing a sequence of the high-resolution frames provided by the NFOV image sensor by matching the location in the area of real space to the corresponding field of view of the NFOV image sensor. The sensor selection device 197 can communicate with camogram generation engine 192 and can access camograms database 180 and store maps database 160 when selecting a sensor that includes the location of an event in its field of view. The camera system 114a can also include logic to communicate with other camera systems in the area of real space when selecting a sensor that provides a best view of the item related to an event. In some cases, a sensor from another camera system can provide a better view of the item in the inventory event. The technology disclosed can select a sensor that provides a good image of the item for item detection and/or item classification.

The camera system 114a comprises an item detection device 198 to identify a particular item in the particular event detected by the event detection device using at least one frame in the selected sequence of high-resolution frames.

The camera system 114a comprises a pose detection device 199 to process image frames from the sequence of low-resolution image frames to determine features of the subjects for identifying and tracking subjects in the area of real space. The pose detection device 199 includes logic to generate poses of subjects by combining various features (such as joints, head, neck, feet, etc.) of the subject. The camera system can include other devices that include logic to support operations of the camera system. For example, the camera system 114a can include a telemetry device (or telemetry agent) 200 to monitor various parameters of the camera system during its operation and generate notifications when one or more parameter values move outside a desired range. The camera system 114a can include other devices as well such as a device to connect the camera system to a management system to update the configuration parameters, access and install operating system and/or firmware updates. The camera system 114a can include devices that include logic to process image frames to detect anomalies in the area of real space, medical emergencies, security threats, products spills, congestions, etc. and generate alerts for store management and/or store employees. Such a device can also include logic to determine when a subject needs help in the area of real space and generate a notification or a message for a store employee to respond to the shopper or move to the location of the shopper to help her.

Referring back to FIG. 1A, for the sake of clarity, only three network nodes 101a, 101b and 101n hosting image recognition engines 112a, 112b, and 112n are shown in the system 100. However, any number of network nodes hosting image recognition engines can be connected to the subject tracking engine 110 through the network(s) 181. In one implementation, the image recognition engines 112a, 112b and 112n can be implemented as part of the respective camera systems 114a, 114b and 114n. In another implementation, a portion of the functionality of the image recognition engines 112a, 112b and 112n can be implemented as part of the respective camera systems 114 a, 114b and 114n. Similarly, the image recognition engines 112a, 112b, and 112n, the subject tracking engine 110, the event detection and classification engine 194, the camogram generation engine 192 and/or other processing engines described herein can execute various operations using more than one network node in a distributed architecture. The subject tracking engine 110 can be implemented as part of the camera system 114a by combining image frames from a plurality of camera systems to generate three dimensional scenes. In one implementation, a plurality of WFOV image sensors can be included in a single camera system to generate three dimensional scenes using sequences of images frames from cameras (or sensors) within a same camera system.

The interconnection of the elements of system 100 will now be described with reference to FIG. 1A. Network(s) 181 couples the network nodes 101a, 101b, and 101n, respectively, hosting image recognition engines 112a, 112b, and 112n, the network node 102 hosting the subject tracking engine 110, the network node 104 hosting the event detection and classification engine 194, the network node 106 hosting the camogram generation engine 192, the planogram database 140, the items database 150, the store map database 160, the camera placement database 170, the camograms database 180, and the video/image database 190. Camera systems 114 are connected to the subject tracking engine 110, the event detection and classification engine 194, and/or the camogram generation engine 192 through network nodes hosting image recognition engines 112a, 112b, and 112n. In one embodiment, the camera systems 114 are installed in a shopping store, such that sets of camera systems 114 (two or more) with overlapping fields of view are positioned to capture images of an area of real space in the store. Two camera systems 114 can be arranged over a first aisle within the store, two camera systems 114 can be arranged over a second aisle in the store, and three camera systems 114 can be arranged over a third aisle in the store. Camera systems 114 can be installed over open spaces, aisles, and near exits and entrances to the shopping store. In such an embodiment, the camera systems 114 can be configured with the goal that customers moving in the shopping store are present in the field of view of two or more camera systems 114 at any moment in time.

Camera systems 114 include sensors that can be synchronized in time with other sensors in the same camera system as well as with sensors in other camera systems 114 installed in the area of real space, so that images are captured at the image capture cycles at the same time, or close in time, and at the same image capture rate (or a different capture rate). The sensors and/or cameras can send respective continuous streams of images at a predetermined rate to respective image processing devices including the network nodes 101a, 101b, and 101n hosting image recognition engines 112a-112n. Images captured by sensors or cameras in all the camera systems 114 covering an area of real space at the same time, or close in time, are synchronized in the sense that the synchronized images can be identified in engines 112a, 112b, 112n, 110, 192 and/or 194 as representing different views of subjects having fixed positions in the real space. For example, in one implementation, the WFOV sensors can send image frames at the rates of ten (10) frames per second (fps) to respective network nodes 101a, 101b and 101n hosting image recognition engines 112a-112n. It is understood that WFOV sensors can capture image data at rates greater than ten frames per second or less than ten frames per second. In one implementation, the NFOV sensors can send one image frame per thirty seconds. The NFOV sensors can capture image frames at a rate greater than one frame per thirty seconds or less than one frame per thirty seconds. Each frame has a timestamp, identity of the camera (abbreviated as “camera_id” or a “sensor_id”), and a frame identity (abbreviated as “frame_id”) along with the image data. An image frame can also include a camera system identifier. In some cases, a separate mapping can be maintained to determine the camera system to which a sensor or a camera belongs. As described above other embodiments of the technology disclosed can use different types of sensors such as image sensors, ultrasound sensors, thermal sensors, ultra-wideband, depth sensors, and/or Lidar, etc. Images can be captured by sensors at frame rates greater than 30 frames per second, such as 40 frames per second, 60 frames per second or even at higher image capturing rates, or lower than thirty (30) frames per second, such as ten (10) frames per second, one (1) frame per second, or even at lower image capturing rates. In one implementation, the images are captured at a higher frame rate when an inventory event such as a put or a take or a touch of an item is detected in the field of view of a sensor. In such an embodiment, when no inventory event is detected in the field of view of a sensor, the images are captured at a lower frame rate.

In one implementation, the camera systems 114 can be installed overhead and/or at other locations, so that in combination, the fields of view of the cameras encompass an area of real space in which the tracking is to be performed, such as in a shopping store.

In one implementation, each image recognition engine 112a, 112b, and 112n is implemented as a deep learning algorithm such as a convolutional neural network (abbreviated CNN). In such an embodiment, the CNN is trained using a training database. In an embodiment described herein, image recognition of subjects in the area of real space is based on identifying and grouping features of the subjects such as joints, recognizable in the images, where the groups of joints (e.g., a constellation) can be attributed to an individual subject. For this joints-based analysis, the training database has a large collection of images for each of the different types of joints for subjects. In the example embodiment of a shopping store, the subjects are the customers moving in the aisles between the shelves. In an example embodiment, during training of the CNN, the system 100 is referred to as a “training system.” After training the CNN using the training database, the CNN is switched to production mode to process images of customers in the shopping store in real time.

The technology disclosed is related to camera systems 114 that can be used for tracking inventory items placed on inventory display structures in the area of real space. The technology disclosed can also track subjects in a shopping store and identify actions of subjects including takes and puts of objects such as inventory items on inventory locations such as shelves or other types of inventory display structures. Other types of inventory events can also be detected such as when a subject touches, rotates and/or moves an item on its location without taking the item. The technology disclosed includes logic to detect what items are positioned on which shelves as this information changes over time. The detection and classification of items is challenging due to subtle variations between items. Additionally, the items are taken and placed on shelves in environments with occlusions that block the view of the cameras. The technology disclosed can reliably detect inventory events and classify the inventory events as takes and puts of items on shelves. To support the reliable detection and classification of inventory events and inventory items related to inventory events, the technology disclosed generates and updates camograms of the area of real space.

Camograms can be considered as maps of items placed on inventory display structures such as shelves, or placed on the floor, etc. Camograms can include images of inventory display structures with classification of inventory items positioned on the shelf at their respective locations (e.g., at respective “cells” as described in more detail below). When a shelf is in the field of view of the camera, the system 100 can detect which inventory items are positioned on that shelf and where the specific inventory items are positioned on the shelf with a high level of accuracy. The technology disclosed can associate an inventory item taken from the shelf to a subject such as a shopper or associate the inventory item to an employee of the store who is stocking the inventory items.

The technology disclosed can perform detection and classification of inventory items. The detection task in the context of a cashier-less shopping store is to identify whether an item is taken from a shelf by a subject such as a shopper. In some cases, it is also possible to detect whether an item is placed on a shelf by a subject who can be a store employee to record a stocking event. The classification task is to identify what item was taken from the shelf or placed on the shelf. The event detection and classification engine 194 includes logic to detect inventory events (such as puts and takes) in the area of real space and classify inventory items detected in the inventory event. In one implementation, the event detection and classification engine 194 can be implemented entirely or partially as part of the camera systems 114. The subject tracking engine 110 includes logic to track subjects in the area of real space by processing images captured by sensors positioned in the area of real space.

Camograms can support the detection and classification tasks by identifying the location on the shelf from where an item has been taken from or placed at. The technology disclosed includes systems and methods to generate, update and utilize camograms for detection and classification of items in a shopping store. The technology disclosed includes logic to use camograms for other tasks in a cashier-less store such as detecting size of an inventory item. Updating the camograms (e.g., the map of the area of real space) takes time and processing power. The technology disclosed implements techniques that eliminate unnecessarily updating the camograms (or portions thereof) when inventor items are shifted, rotated, and/or tilted, yet they remain in essentially the same location (e.g., cell). In other words, the system 100 can skip updating the camograms when the inventory items have moved slightly, but still remain in the same location (or they have moved to another appropriately designated location).

The technology disclosed includes systems and methods to detect changes to portions of camograms and apply updates to only those portions of camograms that have been updated, such as when one or more new items are placed in a shelf or when one or more items have been taken from a shelf. The technology disclosed includes a trigger-based system that can process a signal and/or signals received from sensors in the area of real space to detect changes to a portion or portions of an image of an area of real space (e.g., camograms). The signals can be generated by other processing engines that process the images captured by sensors and output signals indicating a change in a portion of the area of real space. Applying updates to only those portions of camograms in which a change has occurred improves the efficiency of maintaining the camograms and reduces the computational resources required to update camograms over time. In busy shopping stores, the placement of items on shelves can change frequently, therefore a trigger-based system enables real time or near real time updates to camograms. The updated camogram improves operations of an autonomous shopping store by reliably detecting which item was taken by a shopper and also providing a real time inventory status to store management.

The technology disclosed implements a computer vision-based system that includes a plurality of sensors or cameras having overlapping fields of view. Some difficulties are encountered when identifying inventory items, as a result of images of inventory items being captured with steep perspectives and partial occlusions. This can make it difficult to correctly detect or determine sizes of items (e.g., an 8 ounce can of beverage of brand “X” or a 12 ounce can of beverage of brand “X”) as items of the same type (or product) with different sizes can be placed on shelves with no clear indication of sizes on shelves (e.g., the shelf may not be labeled to distinguish between 8 ounce can and 12 ounce can). Current machine vision-based technology has difficulty determining whether a larger or smaller version of the same type of item is placed on the shelf. One reason for this difficulty is due to different distances of various cameras to the inventory item. The image of an inventory item from one camera can appear larger as compared to the image captured from another camera because of different distances of the cameras to the inventory item and also due to their different perspectives. The technology disclosed includes image processing and machine learning techniques that can detect and determine sizes of items of the same product placed in inventory display structures. This provides an additional input to the item classification model further improving the accuracy of item classification results. Further details of camograms are presented in the following section.

### Camogram

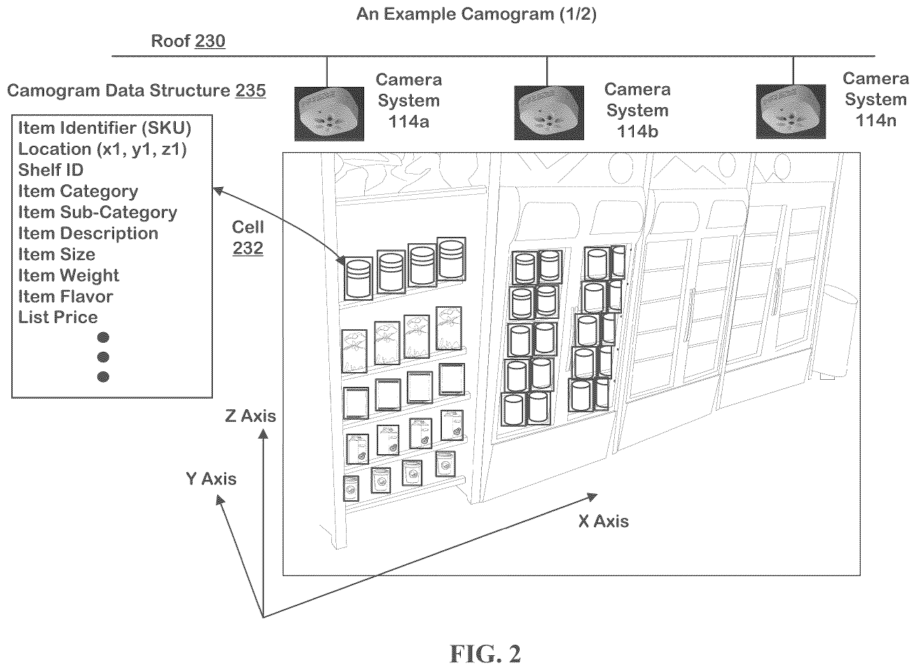

FIG. 2 presents an example camogram superimposed on the shelves or inventory display structures. The camogram can be considered as a map of inventory items placed in the area of real space. The map includes locations of cells or boxes in the map. The cells or boxes can be arranged in rows and columns. An inventory item is located in the location of a cell in the map. The cell encloses the inventory item. For example, a canned inventory item is located in the location of the cell 232. The cell 232 is shown as enclosing the canned item placed on a top left-most position of the shelf. When a shelf is in the field of view of a camera, the technology disclosed can detect what products are positioned on a shelf and where (location in two-dimensions or 3-dimensions) the specific products are positioned on the shelf with a high level of accuracy. The technology disclosed can associate an item taken from the shelf or placed on a shelf to a subject such as a shopper or a store employee, etc.

FIG. 2 shows example inventory display structures in which items are placed on shelves. A plurality of camera systems 114 (such as camera system 114a, camera system 114b, camera system 114n) are positioned on the ceiling or roof 230 and oriented to view the shelves and open spaces in the shopping store. Only three camera systems 114a, 114b and 114n are shown for illustration purposes. The inventory items positioned in the shelf are identified by the machine vision technology and information of the detected items are stored in camogram data structure 235. The data structure 235 can store information related to inventory items positioned in one cell (232) or more than one cell. Some example data stored in the camogram data structure is shown in FIG. 2 including item identifier (such as a SKU), location of the item in the area of real space (x1, y1, z1), shelf identifier (shelf ID), item category, item sub-category, item description, item size (such as small, medium, large, etc.), weight of item (such as in grams, lbs., etc.), item volume (such as in ml, etc.) flavor of item, and/or item price, etc. It is understood that additional data related to inventory items can be stored in the camogram data structure. The camogram data is stored in the camogram database 180. The data in the camogram database can be linked to inventory items data in the items database 150 using a foreign-key relationship such as item's SKU or any other type of item identifier.

In the example of a shopping store, the subjects move in the aisles and in open spaces. The subjects take items from inventory locations on shelves in inventory display structures. In one example of inventory display structures, shelves are arranged at different levels (or heights) from the floor and inventory items are stocked on the shelves. The shelves can be fixed to a wall or placed as freestanding shelves forming aisles in the shopping store. Other examples of inventory display structures include, pegboard shelves, magazine shelves, rotating (e.g., lazy susan type) shelves, warehouse shelves, and/or refrigerated shelving units. In some instances such as in the case of refrigerated shelves, the items in the shelves may be partially or completely occluded by a door at certain points of time. In such cases, the subjects open the door to take an item or place an item on the shelf. The inventory items can also be stocked in other types of inventory display structures such as stacking wire baskets, dump bins, etc. The subjects can also put items back on the same shelves from where they were taken or on another shelf. In such cases, the camogram may need to be updated to reflect a different item now positioned in a cell which previously referred to another item.

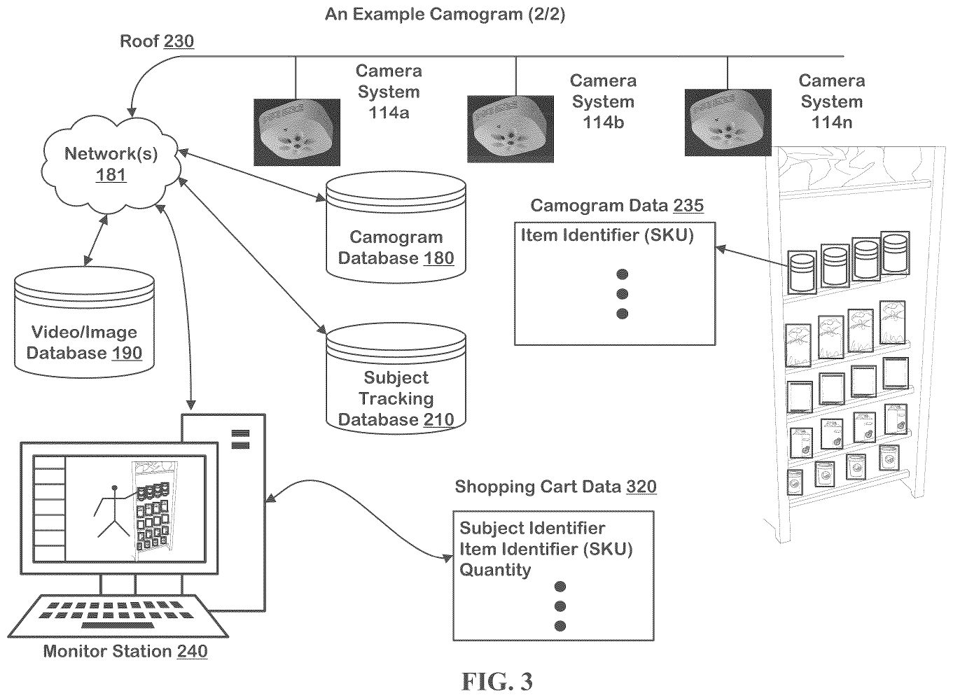

FIG. 3 shows selected components of a system that can be used to generate or update a camogram. The system shown in FIG. 3 includes multiple camera systems 114 positioned over an area of real space. Only three camera systems, 114a, 114b and 114n are shown for illustration purposes. The camera systems (e.g., 114a, 114b and 114n) can be installed at the ceiling or roof 230 and oriented to have shelves and open areas of the real space such as the shopping store in their respective fields of view. The cameras can be connected to a cloud-based storage database system or on-premises database system to store data in the video/image database 190. The system can include a plurality of monitoring systems or monitoring stations 240. The system includes “camera system selection” or “camera/sensor selection” logic that can select camera systems and/or cameras or sensors in a particular camera system to provide a view of the subject moving in the shopping store and taking items from the shelves or placing items on the shelves. The camera selection logic can recommend multiple cameras with a good view of the subject. The monitor can choose one or more cameras to view the subject from the recommended cameras. The monitor can identify takes of items by a subject by using appropriate user interface elements. In one embodiment, the system uses the event detection and classification engine 194 to detect takes of items and puts of items by a subject. The takes and puts of inventory items can be indicated on the user interface on the monitor stations 240 and the monitor can review the takes and puts to confirm or reject one or more detected takes and puts. In another embodiment, the system can use trained machine learning models to process images captured by the cameras to detect takes and puts of items by subjects. Trained machine learning models can then be invoked to detect changes to portions of camograms from where items have been taken or where items have been placed. The technology disclosed can then automatically update camograms (e.g., the camogram database 180) representing portions of shelves where changes have been detected.

When an item is detected to be taken by a subject and classified using the event detection and classification engine 194, the item is added to the subject's shopping cart. An example shopping cart data 320 is shown in FIG. 3. The shopping cart (e.g., the shopping cart data structure 320) of a subject can include a subject identifier, an item identifier (such as SKU), a quantity per item and/or other attributes including a total amount to be charged to subject's account for items in her shopping cart. The shopping cart can include additional information such as discounts applied or other information related to the shopper's visit to the shopping store such as timestamp of when the item was taken by the subject. Information such as the camera or sensor identifier, camera system identifier, and frame identifier, which was used to detect and classify the item can be included in the shopping cart or log data structure. The shopping cart data 320 can be stored in a subject database or in a separate shopping cart database that is linked to the subject database using a subject identifier or another unique identifier to track subjects.

### Subject Tracking Engine

The subject tracking engine 110, hosted on the network node 102 receives, in this example, continuous streams of arrays of joints data structures for the subjects from image recognition engines 112a-112n and can retrieve and store information from and to a subject tracking database 210. In one implementation, the subject tracking engine 110 can be implemented as part of the camera system 114a, 114b and 114n. A plurality of camera systems can communicate with each other, directly, or via a server to implement the logic to track subjects in the area of real space. The subject tracking engine 110 processes the arrays of joints data structures identified from the sequences of images received from the cameras at image capture cycles. It then translates the coordinates of the elements in the arrays of joints data structures corresponding to images in different sequences into candidate joints having coordinates in the real space. For each set of synchronized images, the combination of candidate joints identified throughout the real space can be considered, for the purposes of analogy, to be like a galaxy of candidate joints. For each succeeding point in time, movement of the candidate joints is recorded so that the galaxy changes over time. The output of the subject tracking engine 110 is used to locate subjects in the area of real space during identification intervals. One image in each of the plurality of sequences of images, produced by the cameras, is captured in each image capture cycle.

The subject tracking engine 110 uses logic to determine groups or sets of candidate joints having coordinates in real space as subjects in the real space. For the purposes of analogy, each set of candidate points is like a constellation of candidate joints at each point in time. In one embodiment, these constellations of joints are generated per identification interval as representing a located subject. Subjects are located during an identification interval using the constellation of joints. The constellations of candidate joints can move over time. A time sequence analysis of the output of the subject tracking engine 110 over a period of time, such as over multiple temporally ordered identification intervals (or time intervals), identifies movements of subjects in the area of real space. The system can store the subject data including unique identifiers, joints and their locations in the real space in the subject database.

In an example embodiment, the logic to identify sets of candidate joints (i.e., constellations) as representing a located subject comprises heuristic functions is based on physical relationships amongst joints of subjects in real space. These heuristic functions are used to locate sets of candidate joints as subjects. The sets of candidate joints comprise individual candidate joints that have relationships according to the heuristic parameters with other individual candidate joints and subsets of candidate joints in a given set that has been located, or can be located, as an individual subject.

Located subjects in one identification interval can be matched with located subjects in other identification intervals based on location and timing data that can be retrieved from and stored in the subject tracking database 210. An identification interval can include one image for a given timestamp or it can include a plurality of images from a time interval. Located subjects matched this way are referred to herein as tracked subjects, and their location can be tracked in the system as they move about the area of real space across identification intervals. In the system, a list of tracked subjects from each identification interval over some time window can be maintained, including for example by assigning a unique tracking identifier to members of a list of located subjects for each identification interval, or otherwise. Located subjects in a current identification interval are processed to determine whether they correspond to tracked subjects from one or more previous identification intervals. If they are matched, then the location of the tracked subject is updated to the location of the current identification interval. Located subjects not matched with tracked subjects from previous intervals are further processed to determine whether they represent newly arrived subjects, or subjects that had been tracked before, but have been missing from an earlier identification interval.

Tracking all subjects in the area of real space is important for operations in a cashier-less store. For example, if one or more subjects in the area of real space are missed and not tracked by the subject tracking engine 110, it can lead to incorrect logging of items taken by the subject causing errors in generation of an item log (e.g., shopping cart data 320) for this subject. The technology disclosed can implement a subject persistence engine (not illustrated) to find any missing subjects in the area of real space.

In one embodiment, the image analysis is anonymous, i.e., a unique tracking identifier assigned to a subject created through joints analysis does not identify personal identification details (such as names, email addresses, mailing addresses, credit card numbers, bank account numbers, driver's license number, etc.) of any specific subject in the real space. The data stored in the subject's database does not include any personal identification information. Operations of the subject persistence processing engine and the subject tracking engine 110 do not use any personal identification including biometric information associated with the subjects.

In one embodiment, the tracked subjects are identified by linking them to respective “user accounts” containing for example preferred payment methods provided by the subject. When linked to a user account, a tracked subject is characterized herein as an identified subject. Track subjects are linked with items picked up on the store, and linked with a user account, for example, and upon exiting the store, an invoice can be generated and delivered to the identified subject, or a financial transaction executed online to charge the identified subject using the payment method associated with their accounts. The identified subjects can be uniquely identified, for example, by unique account identifiers or subject identifiers, etc. In the example of a cashier-less store, as the customer completes shopping by taking items from the shelves, the system processes payment of items bought by the customer.

The system can include other processing engines such as an account matching engine (not illustrated) to process signals received from mobile computing devices carried by the subjects to match the identified subjects with their user accounts. The account matching can be performed by identifying locations of mobile devices executing client applications in the area of real space (e.g., the shopping store) and matching locations of mobile devices with locations of subjects, without use of personal identifying biometric information from the images.

Referring to FIG. 1A, the actual communication path to the network node 106 hosting the camogram generation engine 192, the network node 104 hosting the event detection and classification engine 194, the network node 102 hosting the subject tracking engine 110 and the camera systems 114 through the network 181 can be point-to-point over public and/or private networks. The communications can occur over a variety of networks 181, e.g., private networks, VPN, MPLS circuit, or Internet, and can use appropriate application programming interfaces (APIs) and data interchange formats, e.g., Representational State Transfer (REST), JavaScript™ Object Notation (JSON), Extensible Markup Language (XML), Simple Object Access Protocol (SOAP), Java™ Message Service (JMS), Protobuf, and/or Java Platform Module System. All of the communications can be encrypted. The communication is generally over a network such as a LAN (local area network), WAN (wide area network), telephone network (Public Switched Telephone Network (PSTN), Session Initiation Protocol (SIP), wireless network, point-to-point network, star network, token ring network, hub network, and/or Internet, inclusive of the mobile Internet, via protocols such as EDGE, 3G, 4G LTE, 5G, Wi-Fi, and/or WiMAX. Additionally, a variety of authorization and authentication techniques, such as username/password, Open Authorization (OAuth), Kerberos, SecureID, digital certificates and more, can be used to secure the communications.

The technology disclosed herein can be implemented in the context of any computer-implemented system including a database system, a multi-tenant environment, or a relational database implementation like an Oracle™ compatible database implementation, an IBM DB2 Enterprise Server™ compatible relational database implementation, a MySQL™ and/or PostgreSQL™ compatible relational database implementation and/or a Microsoft SQL Server™ compatible relational database implementation and/or a NoSQL™ non-relational database implementation such as a Vampire™ compatible non-relational database implementation, an Apache Cassandra™ compatible non-relational database implementation, a BigTable™ compatible non-relational database implementation and/or an HBase™ and/or DynamoDB™ compatible non-relational database implementation. In addition, the technology disclosed can be implemented using different programming models like MapReduce™, bulk synchronous programming, MPI primitives, etc. and/or different scalable batch and stream management systems like Apache Storm™, Apache Spark™, Apache Kafka™, Apache Flink™ Truviso™, Amazon Elasticsearch Service™, Amazon Web Services™ (AWS), IBM Info-Sphere™, Borealis™, and/or Yahoo! S4™.

### Camera Arrangement

The camera systems 114 are arranged to track subjects (or entities) in a three dimensional (abbreviated as 3D) real space. In the example embodiment of the shopping store, the real space can include the area of the shopping store where items for sale are stacked in shelves. A point in the real space can be represented by an (x, y, z) coordinate system. Each point in the area of real space for which the system is deployed is covered by the fields of view of two or more camera systems 114.

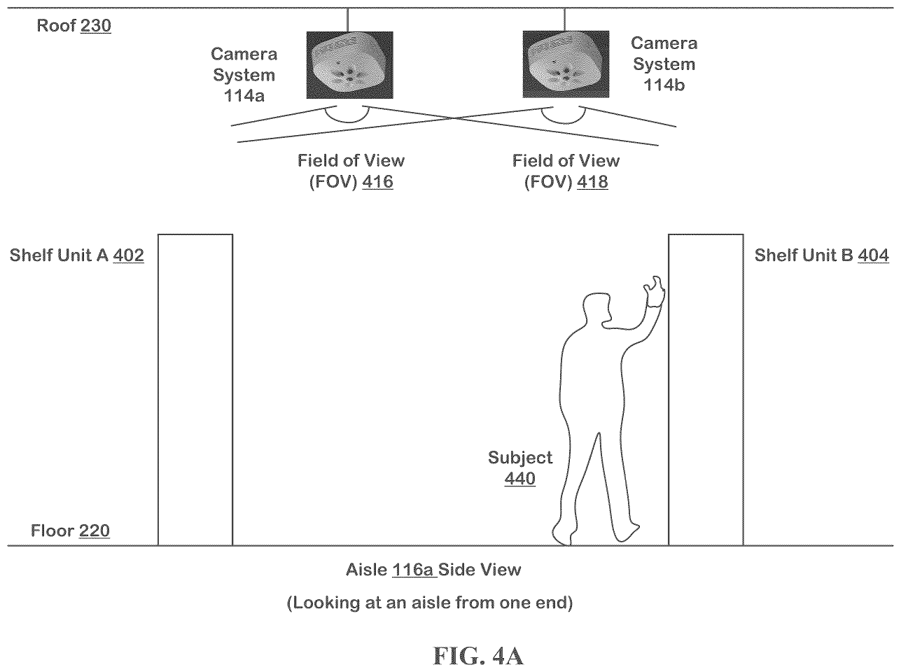

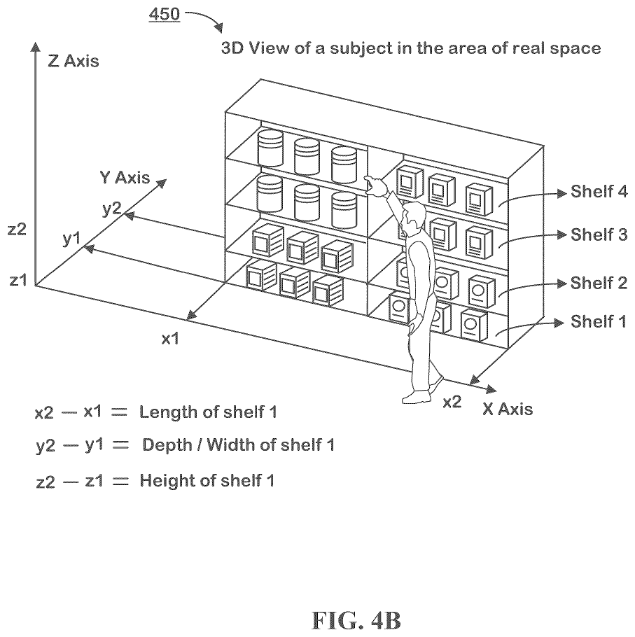

In a shopping store, the shelves and other inventory display structures can be arranged in a variety of manners, such as along the walls of the shopping store, or in rows forming aisles or a combination of the two arrangements. FIG. 4A shows an arrangement of shelf unit A 402 and shelf unit B 404, forming an aisle 116a, viewed from one end of the aisle 116a. Two camera systems, 114a and 114b are positioned over the aisle 116a at a predetermined distance from a ceiling or roof 230 and a floor 220 of the shopping store above the inventory display structures, such as shelf units A 402 and shelf unit B 404. The camera systems 114a and 114b comprise cameras or sensors disposed over and having fields of view encompassing respective parts of the inventory display structures and floor area in the real space. As each camera system can have one or more NFOV sensors and one or more WFOV sensors, only the fields of view of one WFOV sensor per camera system is shown in FIG. 4A. For example, a field of view 416 is of a WFOV camera in the camera system 114a and a field of view 418 is of a WFOV camera in the camera system 114b. The fields of view of the two WFOV sensors overlap as shown in FIG. 4A. The locations of subjects are represented by their positions in three dimensions of the area of real space. In one implementation, the subjects are represented as a constellation of joints in real space. In this implementation, the positions of the joints in the constellation of joints are used to determine the location of a subject in the area of real space. The camera systems 114 can include Pan-Tilt-Zoom cameras, 360-degree cameras, and/or combinations thereof that can be installed in the real space.

In the example implementation of the shopping store, the real space can include the entire floor 220 in the shopping store. Camera systems 114 are placed and oriented such that areas of the floor 220 and shelves can be seen by at least two cameras. The camera systems 114 also cover floor space in front of the shelve unit A 402 and shelf unit B 404. Camera angles are selected to have both steep perspective, straight down, and angled perspectives that give more full body images of the customers (subjects). In one example embodiment, the camera systems 114 are configured at an eight (8) foot height or higher throughout the shopping store. In one embodiment, the area of real space includes one or more designated unmonitored locations such as restrooms.

Entrances and exits for the area of real space, which act as sources and sinks of subjects in the subject tracking engine 110, are stored in the store map database 160. Also, designated unmonitored locations are not in the field of view of camera systems 114, which can represent areas in which tracked subjects may enter, but must return into the area being tracked after some time, such as a restroom. The locations of the designated unmonitored locations are stored in the store map database 160. The locations can include the positions in the real space defining a boundary of the designated unmonitored location and can also include location of one or more entrances or exits to the designated unmonitored location.

### Three-Dimensional Scene Generation

In FIG. 4A, a subject 440 is standing by an inventory display structure shelf unit B 404, with one hand positioned close to a shelf (not visible) in the shelf unit B 404. FIG. 4B is a perspective view of the shelf unit B 404 with four shelves, shelf 1, shelf 2, shelf 3, and shelf 4 positioned at different levels from the floor. The inventory items are stocked on the shelves.

A location in the real space is represented as a (x, y, z) point of the real space coordinate system. “x” and “y” represent positions on a two-dimensional (2D) plane which can be the floor 220 of the shopping store. The value “z” is the height of the point above the 2D plane at floor 220 in one configuration. The system combines 2D images from two or more cameras to generate the three-dimensional positions of joints in the area of real space. This section presents a description of the process to generate 3D coordinates of joints. The process is also referred to as 3D scene generation.

Before using the system 100 in a training or inference mode to track the inventory items, two types of camera calibrations: internal and external, are performed. In internal calibration, the internal parameters of sensors or cameras in camera systems 114 are calibrated. Examples of internal camera parameters include focal length, principal point, skew, fisheye coefficients, etc. A variety of techniques for internal camera calibration can be used. One such technique is presented by Zhang in “A flexible new technique for camera calibration” published in IEEE Transactions on Pattern Analysis and Machine Intelligence, Volume 22, No. 11, November 2000.

In external calibration, the external camera parameters are calibrated in order to generate mapping parameters for translating the 2D image data into 3D coordinates in real space. In one embodiment, one subject (also referred to as a multi-joint subject), such as a person, is introduced into the real space. The subject moves through the real space on a path that passes through the field of view of each of the cameras or the sensor in camera systems 114. At any given point in the real space, the subject is present in the fields of view of at least two cameras forming a 3D scene. The two cameras, however, have a different view of the same 3D scene in their respective two-dimensional (2D) image planes. A feature in the 3D scene such as a left-wrist of the subject is viewed by two cameras at different positions in their respective 2D image planes.

A point correspondence is established between every pair of cameras with overlapping fields of view for a given scene. Since each camera 114 has a different view of the same 3D scene, a point correspondence is determined using two pixel locations (one location from each camera with overlapping field of view) that represent the projection of the same point in the 3D scene. Many point correspondences are identified for each 3D scene using the results of the image recognition engines 112a to 112n for the purposes of the external calibration. The image recognition engines 112a to 112n identify the position of a joint as (x, y) coordinates, such as row and column numbers, of pixels in the 2D image space of respective cameras or sensors in camera systems 114. In one embodiment, a joint is one of 19 different types of joints of the subject. As the subject moves through the fields of view of different cameras, the subject tracking engine 110 receives (x, y) coordinates of each of the 19 different types of joints of the subject used for the calibration from camera systems 114 per image.

For example, consider an image from a camera A (such as a WFOV sensor in camera system 114a) and an image from a camera B (such as WFOV sensor in camera system 114b) both taken at the same moment in time and with overlapping fields of view. There are pixels in an image from camera A that correspond to pixels in a synchronized image from camera B. Consider that there is a specific point of some object or surface in view of both camera A and camera B and that point is captured in a pixel of both image frames. In external camera calibration, a multitude of such points are identified and referred to as corresponding points. Since there is one subject in the field of view of camera A and camera B during calibration, key joints of this subject are identified, for example, the center of left wrist. If these key joints are visible in image frames from both camera A and camera B, then it is assumed that these represent corresponding points. This process is repeated for many image frames to build up a large collection of corresponding points for all pairs of cameras with overlapping fields of view. In one embodiment, images are streamed off of all cameras at a rate of 30 FPS (frames per second) or more or less and a suitable resolution and aspect ratio, such as 720×720 pixels, but can be greater or smaller and with a different ratio such as 1:1, 3:4, 16:9, 9:16, or any other aspect ratio, in full RGB (red, green, and blue) color or in other color and/or non-color schemes. These images may be in the form of one-dimensional arrays (also referred to as flat arrays).

The large number of images collected above for a subject is used to determine corresponding points between cameras with overlapping fields of view. Consider two cameras A and B with overlapping fields of view. The plane passing through camera centers of cameras A and B and the joint location (also referred to as feature point) in the 3D scene is called the “epipolar plane”. The intersection of the epipolar plane with the 2D image planes of the cameras A and B defines the “epipolar line”. Given these corresponding points, a transformation is determined that can accurately map a corresponding point from camera A to an epipolar line in camera B's field of view that is guaranteed to intersect the corresponding point in the image frame of camera B. Using the image frames collected above for a subject, the transformation is generated. It is known in the art that this transformation is non-linear. The general form is furthermore known to require compensation for the radial distortion of each camera's lens, as well as the non-linear coordinate transformation moving to and from the projected space. In external camera calibration, an approximation to the ideal non-linear transformation is determined by solving a non-linear optimization problem. This non-linear optimization function is used by the subject tracking engine 110 to identify the same joints in outputs (arrays of joint data structures) of different image recognition engines 112a to 112n, processing images of sensors or cameras in camera systems 114 with overlapping fields of view. The results of the internal and external camera calibration are stored in a calibration database.

A variety of techniques for determining the relative positions of the points in images captured by sensors or cameras in camera systems 114 in the real space can be used. For example, Longuet-Higgins published, “A computer algorithm for reconstructing a scene from two projections” in Nature, Volume 293, 10 Sep. 1981. This paper presents computing a three-dimensional structure of a scene from a correlated pair of perspective projections when spatial relationship between the two projections is unknown. Longuet-Higgins paper presents a technique to determine the position of each camera in the real space with respect to other cameras. Additionally, their technique allows triangulation of a subject in the real space, identifying the value of the z-coordinate (height from the floor) using images from camera systems 114 with overlapping fields of view. An arbitrary point in the real space, for example, the end of a shelf unit in one corner of the real space, is designated as a (0, 0, 0) point on the (x, y, z) coordinate system of the real space. The technology disclosed can use the external calibration parameters of two cameras with overlapping fields of view to determine a two-dimensional plane on which an inventory item is positioned in the area of real space. An image captured by one of the camera systems 114 can then be warped and re-oriented along the determined two-dimensional plane for determining the size of the inventory item. Details of the item size detection process are presented later in this text.

In an embodiment of the technology disclosed, the parameters of the external calibration can be stored in two data structures. The first data structure stores intrinsic parameters. The intrinsic parameters represent a projective transformation from the 3D coordinates into 2D image coordinates. The first data structure contains intrinsic parameters per camera 114 as shown below. The data values are all numeric floating point numbers. This data structure stores a 3×3 intrinsic matrix, represented as “K” and distortion coefficients. The distortion coefficients include six radial distortion coefficients and two tangential distortion coefficients. Radial distortion occurs when light rays bend more near the edges of a lens than they do at its optical center. Tangential distortion occurs when the lens and the image plane are not parallel. The following data structure shows values for the first camera only. Similar data is stored for all the camera systems 114.

```
{
  1: {
    K: [[x, x, x], [x, x, x], [x, x, x]],
    distortion_coefficients: [x, x, x, x, x, x, x, x]
  },
}
```

The camera recalibration method can be applied to WFOV and NFOV cameras. The radial distortion parameters described above can model the (barrel) distortion of a WFOV camera (or 360 degree camera). The intrinsic and extrinsic calibration process described here can be applied to the WFOV camera. However, the camera model using these intrinsic calibration parameters (data elements of K and distortion coefficients) can be different.

The second data structure stores per pair of cameras or sensors (in a same camera system or across different camera systems): a 3×3 fundamental matrix (F), a 3×3 essential matrix the, a 3×4 projection matrix (P), a 3×3 rotation matrix (R) and a 3×1 translation vector (t). This data is used to convert points in one camera's reference frame to another camera's reference frame. For each pair of cameras, eight homography coefficients are also stored to map the plane of the floor 220 from one camera to another. A fundamental matrix is a relationship between two images of the same scene that constrains where the projection of points from the scene can occur in both images. Essential matrix is also a relationship between two images of the same scene with the condition that the cameras are calibrated. The projection matrix gives a vector space projection from 3D real space to a subspace. The rotation matrix is used to perform a rotation in Euclidean space. Translation vector “t” represents a geometric transformation that moves every point of a figure or a space by the same distance in a given direction. The homography_floor_coefficients are used to combine images of features of subjects on the floor 220 viewed by cameras with overlapping fields of views. The second data structure is shown below. Similar data is stored for all pairs of cameras. As indicated previously, the x's represents numeric floating point numbers.

```
{
  1: {
    2: {
      F: [[x, x, x], [x, x, x], [x, x, x]],
      E: [x, x, x], [x, x, x], [x, x, x]],
      P: [[x, x, x, x], [x, x, x, x], [x, x, x, x]],
      R: [[x, x, x], [x, x, x], [x, x, x]],
      t: [x, x, x],
      homography_floor_coefficients: [x, x, x, x, x, x, x, x]
    }
  },
  .......
}
```

### Two-Dimensional and Three-Dimensional Maps

An inventory location, such as a shelf, in a shopping store can be identified by a unique identifier in the store map database 160 (e.g., shelf_id). Similarly, a shopping store can also be identified by a unique identifier (e.g., store_id) in the store map database 160. Two dimensional (2D) and three dimensional (3D) maps stored in the store map database 160 can identify inventory locations in the area of real space along the respective coordinates. For example, in a 2D map, the locations in the maps define two dimensional regions on the plane formed perpendicular to the floor 220 i.e., XZ plane as shown in FIG. 4B. The map can define an area for inventory locations where inventory items are positioned. In FIG. 4B, a 2D location of the shelf unit can be represented by four coordinate positions (x1, y1), (x1, y2), (x2, y2), and (x2, y1). These coordinate positions define a 2D region on the floor 220 where the shelf is located. Similar 2D areas are defined for all inventory display structure locations, entrances, exits, and designated unmonitored locations in the shopping store. This information is stored in the store map database 160.

In a 3D map, the locations in the map define three dimensional regions in the 3D real space defined by X, Y, and Z coordinates. The map defines a volume for inventory locations where inventory items are positioned. In FIG. 4B, a 3D view 450 of shelf 1 in the shelf unit shows a volume formed by eight coordinate positions (x1, y1, z1), (x1, y1, z2), (x1, y2, z1), (x1, y2, z2), (x2, y1, z1), (x2, y1, z2), (x2, y2, z1), (x2, y2, z2) defining a 3D region in which inventory items are positioned on the shelf 1. Similar 3D regions are defined for inventory locations in all shelf units in the shopping store and stored as a 3D map of the real space (shopping store) in the store map database 160. The coordinate positions along the three axes can be used to calculate length, depth and height of the inventory locations as shown in FIG. 4B.

In one embodiment, the map identifies a configuration of units of volume which correlate with portions of inventory locations on the inventory display structures in the area of real space. Each portion is defined by starting and ending positions along the three axes of the real space. Like 2D maps, the 3D maps can also store locations of all inventory display structure locations, entrances, exits and designated unmonitored locations in the shopping store.

The items in a shopping store are arranged in some embodiments according to a planogram which identifies the inventory locations (such as shelves) on which a particular item is planned to be placed. For example, as shown in FIG. 4B, a left half portion of shelf 3 and shelf 4 are designated for an item (which is stocked in the form of cans).

### Joints Data Structure

The technology disclosed tracks subjects in the area of real space using machine learning models combined with heuristics that generate a skeleton of a subject by connecting the joints of a subject. The position of the subject is updated as the subject moves in the area of real space and performs actions such as puts and takes of inventory items. The image recognition engines 112a-112n receive the sequences of images from camera systems 114 and process images to generate corresponding arrays of joints data structures. The system includes processing logic that uses the sequences of images produced by the plurality of camera to track locations of a plurality of subjects (or customers in the shopping store) in the area of real space. In one embodiment, the image recognition engines 112a-112n identify one of the 19 possible joints of a subject at each element of the image, usable to identify subjects in the area who may be moving in the area of real space, standing and looking at an inventory item, or taking and putting inventory items. The possible joints can be grouped in two categories: foot joints and non-foot joints. The 19^{th} type of joint classification is for all non-joint features of the subject (i.e., elements of the image not classified as a joint). In other embodiments, the image recognition engine may be configured to identify the locations of hands specifically. Also, other techniques, such as a user check-in procedure, may be deployed for the purposes of identifying the subjects and linking the subjects with detected locations of their hands as they move throughout the store. However, note that the subjects identified in the area of real space are anonymous. The subject identifiers assigned to the subjects that are identified in the area of real space are not linked to real world identities of the subjects. The technology disclosed does not store any facial images or other facial or biometric features and therefore, the subjects are anonymously tracked in the area of real space. Examples of joint types that can be used to track subjects in the area of real space are presented below:

### Foot Joints:

Ankle joint (left and right)

### Non-Foot Joints:

Neck
Nose
Eyes (left and right)
Ears (left and right)
Shoulders (left and right)
Elbows (left and right)
Wrists (left and right)
Hip (left and right)
Knees (left and right)

### Not a Joint

An array of joints data structures (e.g., a data structure that stores an array of joint data) for a particular image classifies elements of the particular image by joint type, time of the particular image, and/or the coordinates of the elements in the particular image. The type of joints can include all of the above-mentioned types of joints, as well as any other physiological location on the subject that is identifiable. In one embodiment, the image recognition engines 112a-112n are convolutional neural networks (CNN), the joint type is one of the 19 types of joints of the subjects, the time of the particular image is the timestamp of the image generated by the source camera (or sensor) for the particular image, and the coordinates (x, y) identify the position of the element on a 2D image plane.

The output of the CNN is a matrix of confidence arrays for each image per camera. The matrix of confidence arrays is transformed into an array of joints data structures. A joints data structure is used to store the information of each joint. The joints data structure identifies x and y positions of the element in the particular image in the 2D image space of the camera from which the image is received. A joint number identifies the type of joint identified. For example, in one embodiment, the values range from 1 to 19. A value of 1 indicates that the joint is a left ankle, a value of 2 indicates the joint is a right ankle and so on. The type of joint is selected using the confidence array for that element in the output matrix of CNN. For example, in one embodiment, if the value corresponding to the left-ankle joint is highest in the confidence array for that image element, then the value of the joint number is “1”.

A confidence number indicates the degree of confidence of the CNN in detecting that joint. If the value of confidence number is high, it means the CNN is confident in its detection. An integer-Id is assigned to the joints data structure to uniquely identify it. Following the above mapping, the output matrix of confidence arrays per image is converted into an array of joints data structures for each image. In one embodiment, the joints analysis includes performing a combination of k-nearest neighbors, mixture of Gaussians, and various image morphology transformations on each input image. The result comprises arrays of joints data structures which can be stored in the form of a bit mask in a ring buffer that maps image numbers to bit masks at each moment in time.

### Subject Tracking Using Joints Data Structure

The subject tracking engine 110 is configured to receive arrays of joints data structures generated by the image recognition engines 112a-112n corresponding to images in sequences of images from camera systems 114 having overlapping fields of view. The arrays of joints data structures per image are sent by image recognition engines 112a-112n to the subject tracking engine 110 via the network(s) 181. The subject tracking engine 110 translates the coordinates of the elements in the arrays of joints data structures from 2D image space corresponding to images in different sequences into candidate joints having coordinates in the 3D real space. A location in the real space is covered by the field of views of two or more cameras. The subject tracking engine 110 comprises logic to determine sets of candidate joints having coordinates in real space (constellations of joints) as located subjects in the real space. In one embodiment, the subject tracking engine 110 accumulates arrays of joints data structures from the image recognition engines for all the cameras at a given moment in time and stores this information as a dictionary in the subject tracking database 210, to be used for identifying a constellation of candidate joints corresponding to located subjects. The dictionary can be arranged in the form of key-value pairs, where keys are camera ids and values are arrays of joints data structures from the camera. In such an embodiment, this dictionary is used in heuristics-based analysis to determine candidate joints and for assignment of joints to located subjects. In such an embodiment, a high-level input, processing and output of the subject tracking engine 110 is illustrated in table 1 (see below). Details of the logic applied by the subject tracking engine 110 to create subjects by combining candidate joints and track movement of subjects in the area of real space are presented in U.S. patent application Ser. No. 15/847,796, entitled, “Subject Identification and Tracking Using Image Recognition Engine,” filed on 19 Dec. 2017, now issued as U.S. Pat. No. 10,055,853, which is fully incorporated into this application by reference.

TABLE 1
Inputs, processing and outputs from subject tracking engine 110 in an example embodiment.

| Inputs | Processing | Output |
|---|---|---|
| Arrays of joints data | Create joints dictionary | List of located subjects |
| structures per image and | Reproject joint | located in the real |
| for each joints data | positions in the fields of | space at a moment in |
| structure | view of cameras with | time corresponding to |
| Unique ID | overlapping fields of | an identification interval |
| Confidence number | view to candidate joints | |
| Joint number | | |
| 2D (x, y) position in | | |
| image space | | |

### Subject Data Structure

The subject tracking engine 110 uses heuristics to connect joints identified by the image recognition engines 112a-112n to locate subjects in the area of real space. In doing so, the subject tracking engine 110, at each identification interval, creates new located subjects for tracking in the area of real space and updates the locations of existing tracked subjects matched to located subjects by updating their respective joint locations. The subject tracking engine 110 can use triangulation techniques to project the locations of joints from 2D image space coordinates (x, y) to 3D real space coordinates (x, y, z). A subject data structure can be used to store an identified subject. The subject data structure stores the subject related data as a key-value dictionary. The key is a “frame_id” and the value is another key-value dictionary where key is the camera_id (e.g., of a WFOV camera in a camera system) and value is a list of 18 joints (of the subject) with their locations in the real space. The subject data is stored in a subject database. A subject is assigned a unique identifier that is used to access the subject's data in the subject database.

In one embodiment, the system identifies joints of a subject and creates a skeleton (or constellation) of the subject. The skeleton is projected into the real space indicating the position and orientation of the subject in the real space. This is also referred to as “pose estimation” in the field of machine vision. In one embodiment, the system displays orientations and positions of subjects in the real space on a graphical user interface (GUI). In one embodiment, the subject identification and image analysis are anonymous, i.e., a unique identifier assigned to a subject created through joints analysis does not identify personal identification information of the subject as described above.

For this embodiment, the joints constellation of a subject, produced by time sequence analysis of the joints data structures, can be used to locate the hand of the subject. For example, the location of a wrist joint alone, or a location based on a projection of a combination of a wrist joint with an elbow joint, can be used to identify the location of hand of a subject. Examples of Camera Systems

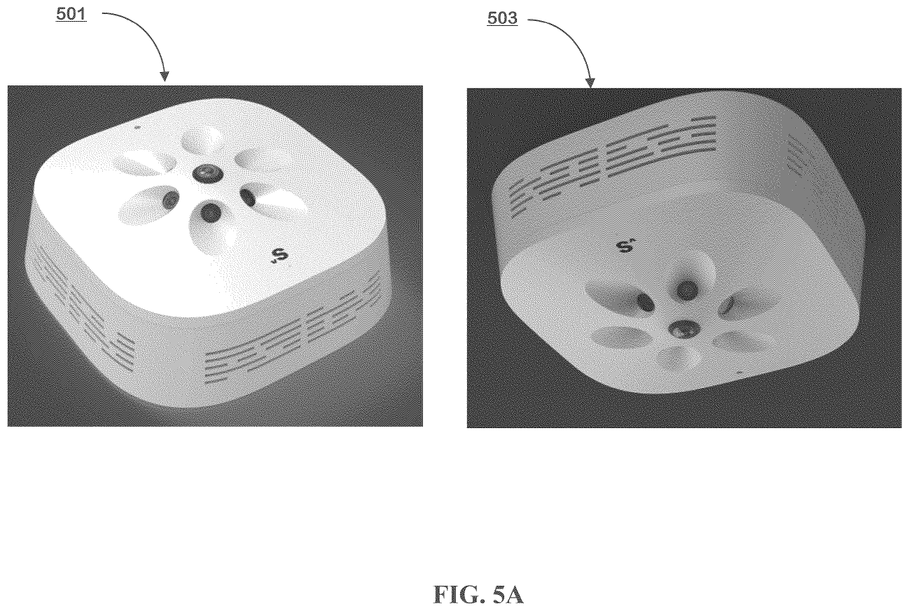

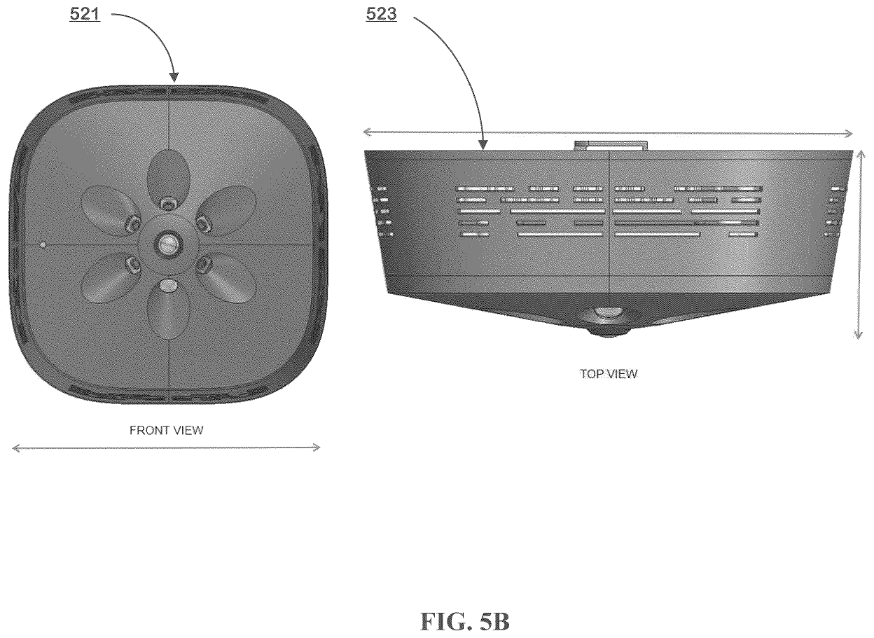

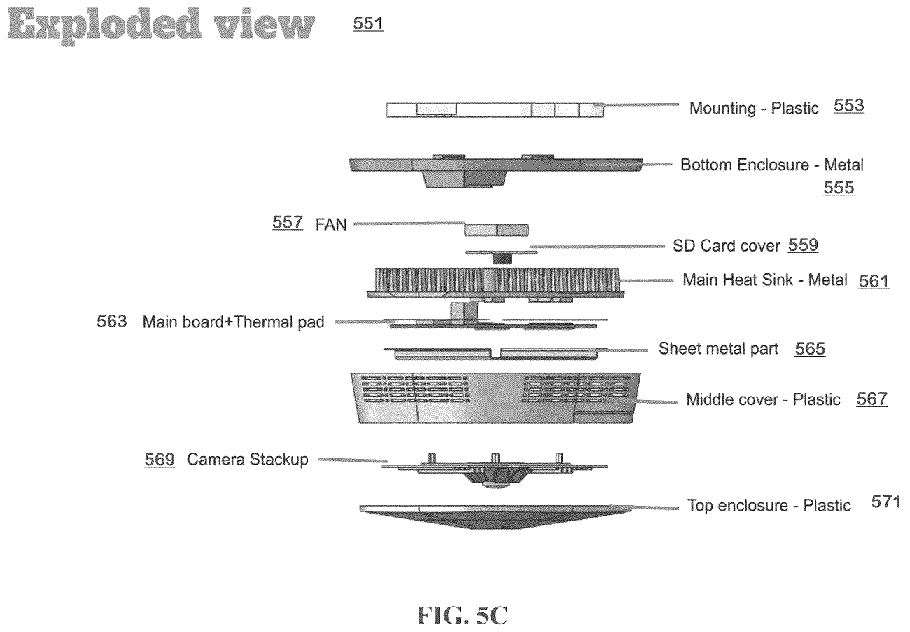

FIGS. 5A to 5C present an example camera system comprising a plurality of sensors (or cameras). These camera systems can be used by the technology disclosed to detect events, identify items related to detected events and/or identify and track subjects. FIG. 5A presents two different views 501 and 503 of the camera system. The camera system shown in FIG. 5A comprises an image sensor assembly comprising at least six narrow field of view (NFOV) sensors and at least one wide field of view (WFOV) sensor. The sensor assembly of camera system of FIG. 5A can include one to twenty or more narrow field of view (NFOV) sensors. More than one WFOV sensors can be included in the sensor assembly. In one instance the NFOV sensors can capture images at higher image resolutions such as 8,000 pixels by 6,000 pixels. Image sensors that can capture images at higher resolutions than 8,000 pixels by 6,000 pixels can be used. The WFOV sensors can capture images at an image resolution of 3,040 pixels by 3,040 pixels. WFOV image sensors that can capture images at a lower resolution than 3,040 pixels by 3,040 pixels can be used. WFOV image sensors that can capture images at a higher resolution than 3,040 pixels by 3,040 pixels can also be used. The cameras and/or sensors (hereinafter cameras) described above can be implemented using, as least, the technology described below. The camera systems can implement artificial intelligence (AI) and edge machine learning (ML). The camera systems can implement multi-device coordination, from software perspective. The camera systems can implement computing on the edge such as identifying subjects, tracking subjects, detecting events and identifying events related to events.

Camera systems including newer versions of the cameras can work alongside camera systems including previous or older versions of cameras. Cameras included in the camera system can capture JPEG for camograms. Sensors on the cameras in the camera system can be 48 megapixels (MP) or more. The cameras included in the camera system can be 4K. For example, wide field of view (WFOV) sensors, which can be used for subject tracking and action recognition (e.g., puts and takes) can be 4K and narrow field of view (NFOV) sensors, which can be used for camogram and other applications, can be 12 MP or greater (e.g., 48 MP). Cameras can be configured to provide 10-12 encoding streams in parallel. Camera sensors can provide a field of view of 50 degrees horizontal (HFOV) and 70 degrees vertical (VFOV) (e.g., portrait), or a field of view of 70 degrees horizontal and 50 degrees vertical (e.g., landscape). Cameras can implement pixel coding. The cameras can be identified based on information added to the exterior (or interior) of the camera. The information can include a barcode or a QR code, or other similar type of visual indicator. Further, the camera systems and/or cameras included in the camera systems can be identified by the system using the cameras using specific identifiers, such as a MAC address, etc. Further, communication components can be included in the cameras, such as Bluetooth, RFID, ultra-wide-band and/or other types of short range and/or long range communications for the purpose of identifying the cameras, as well as conveying other types of information.

FIG. 5B presents a front view (521) and a top view (523) of the camera system of FIG. 5A. The camera system comprises six narrow field of view (NFOV) sensors and one wide field of view (WFOV) sensor. The top view 523 shows openings in the housing of the camera system for air circulation through the camera system and/or sensor assembly. It is understood that the camera system can comprise fewer or more than six NFOV sensors (or cameras) and more than one WFOV sensor (or camera).

FIG. 5C presents an exploded view 551 of the camera system of FIGS. 5A and 5B. The camera system comprises a mounting component 553 that can be used to mount the camera system on any surface. The camera system comprises a bottom enclosure component 555 that can be made of a metallic material. The camera system comprises a fan 557 that can be used for cooling the camera system including the sensor assembly. The camera system comprises a storage card (e.g., an SD card) cover 559 that can be used to house the data storage and/or the memory card. The camera system comprises a main heat sink 561 that includes a finned design to facilitate in cooling of the camera system and/or sensor assembly housing. The heat sink can be manufactured using a metallic material, such as ADC12 Aluminum. The camera system comprises a main board and thermal pad component 563. The main board can comprise electronic components of the camera system. The camera system comprises a sheet metal part 565. The camera system comprises a middle cover 567 that can include openings for air circulation through the camera system housing. The middle cover can be manufactured using plastic materials. The camera system comprises a camera stackup component 569. The camera system comprises a top enclosure component 571 that can be manufactured using plastic and/or metallic materials.

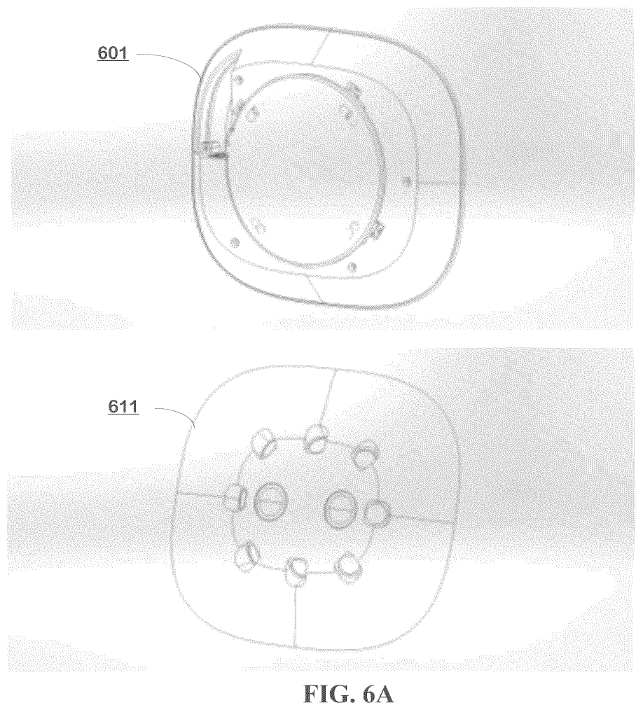

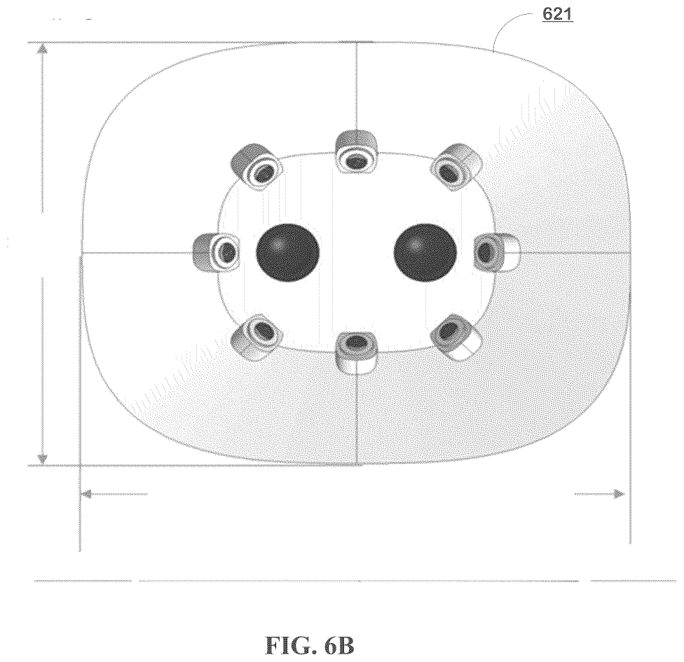

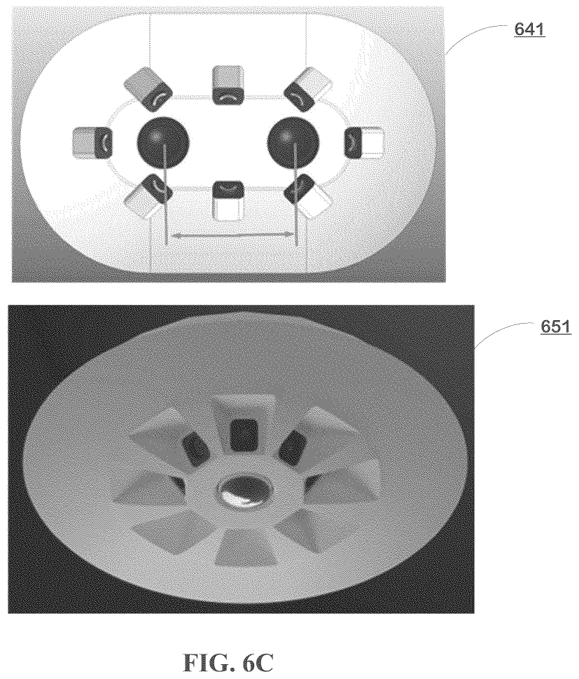

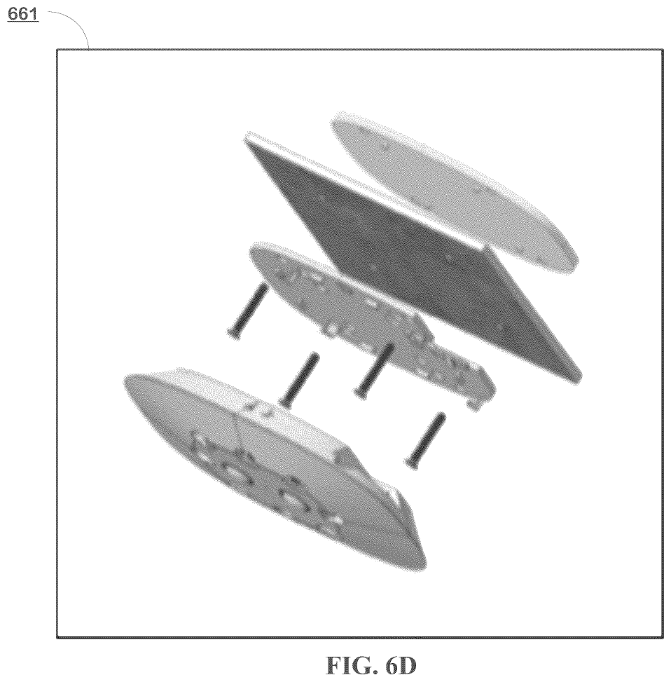

FIG. 6A presents another example camera system. Two views 601 and 611 of the camera system are shown in FIG. 6A. The example camera system in FIG. 6A comprises eight NFOV sensors (or cameras) and two WFOV sensors (or cameras).

FIG. 6B presents another view 621 of the camera system of FIG. 6A. The camera system comprises eight NFOV sensors and two WFOV sensors. The two WFOV sensors can be used for stereo imaging and for generating three dimensional scenes of the area of real space. This can be used for identifying subject in the three-dimensional area of the real space and for tracking subjects in the area of real space. The subject tracking can be performed by combining a plurality of sequences of images captured by WFOV sensors on two or more camera systems placed at different locations in the area of real space. The fields of view of such WFOV sensors in two or more camera systems can overlap to generate the three-dimensional scene of the area of real space.

FIG. 6C presents two example camera systems 641 and 651. The camera system 641 comprises eight NFOV sensors and two WFOV sensors. The camera system 641 has an oval design. The camera system 651 has a circular design and comprises eight NFOV sensors and one WFOV sensor.

FIG. 6D presents an exploded view 661 of the camera system 641 in FIG. 6C. The exploded view shows various structural parts of the camera system.

In one implementation, the NFOV sensors can capture images at an image resolution of 8032 pixels by 6248 pixels and/or 8000 pixels by 6000 pixels. As described above, the camera systems can incorporate NFOV sensors with higher image resolutions and/or lower image resolutions as mentioned above. The cameras and/or sensors can implement 70/50 (H/V FOV), wherein a ratio can be 65×50.

The camera system can include cameras that can implement a 140 degree and/or 160 degree lens (e.g., a 140 VFOV/HFOV, a 160 VFOV/HFOV, or any other combination, as the HFOV and the VFOV can range from 120 to 180 degrees).

For subject tracking, the camera system can include cameras (such as WFOV sensors or cameras) that can have an accuracy of less than 5 cm. For identifying brush-byes, the cameras can track about a ten (10) cm distance between subjects. The camera system can incorporate depth sensors or depth cameras so they can leverage depth information for detecting events, identifying items, identifying and/or tracking subjects. In one implementation, two center sensors can be used for detecting/sensing/computing depth via stereo, which can be beneficial for several types of applications, such as tracking, calibration, layout movement, etc.

As illustrated above, the cameras can have a rectangular shape with a mix of tracking sensors on the perimeter and/or the cameras can have a circular design with or without perimeter sensors. Various field of view lenses can be implemented with a field of view of over 80 degrees and/or a field of view with less than 80 degrees. For example, the cameras can have lenses that have 160 degree horizontal and/or vertical fields of view.

The cameras can implement two overlapping wide angle field of view lenses. A large item sensor can be placed between two shelf cameras with overlap (e.g., 5 degrees of overlap). The cameras can provide a small item (pixel per square) score. For example, for both human reviewers and machine learning models, distinguishing between items using images is dependent on a number of pixels assigned to a designated measurement (e.g., each cm) of an object. If part of an image representing the item is too small, then the item can be confused with other items or non-items. This is especially true for small items, such as candy bars and chewing gum packages. Therefore, it is desirable to have a larger pixel per designated measurement (e.g., each square cm).

The cameras can implement full or edge processing and/or the processing can be performed in the cloud. The cameras can implement two depth sensors.

A wide field of view can be implemented with 140 to 160 degrees for the vertical field of view.

The cameras can be implemented with or without an ethernet jack. The cameras can include a PCIE connection and/or a USB connection. The cameras can implement pixel binning. The cameras can have a dome shape to an annulus shape with flat (e.g., glass) cover. The cameras can include an internal solid state drive (SSD), with storage ranging from, for example, 500 GB to 2 TB. The cameras can have a resolution of 13 MP, can be auto focus and/or fixed focus and can have a variable framerate.

The cameras can include 8 or more or fewer sensors having a 70 degree vertical field of view and a 50 degree horizontal field of view, 90 degree flexible printed cable (FPC) connection, with auto focus and/or fixed focus. The cameras can also include one or more sensors having a 120-160 degree elevation field of view and a 360 degree azimuth field of view.

The cameras can operate in a low temperature environment, such as a refrigerator (e.g., ten (10) degrees Celsius). Humidity can be addressed using a desiccant. A heat sink can be included on the exterior of the cameras. A sealing can be provided between the camera and the surface to which it is attached (e.g., a ceiling) or the cameras can have a grommet and/or ring insert configuration.

The cameras can have various electrical configurations. For example, the cameras can include an ethernet interface (RGMII with PoE+ or PoE++). The cameras can include one or more systems on modules (SOMs) that can be connected by USB and//or PCIe for communications.

The cameras can implement internal (e.g., edge) processing to combine multiple frames of data to capture changes and/or movement spread across several frames into one frame and can reduce a number of frames by eliminating frames that do not capture any background or foreground changes. The cameras can implement various coding and data reduction techniques to stream sensor data to servers on our off premises, even under low bandwidth conditions (e.g., less than 5 MP per second). The cameras can implement AI models to process and analyze data before sensor data is transmitted to other devices and the cameras can implement algorithms to determine depts and can perform pixel level diffing.

The cameras described herein can include Bluetooth (or other short distance communication) capabilities to communicate to other cameras and/or other devices within the store.

The camera can include fins to increase a surface area to increase heat sinking (heat dissipation) characteristics. The camera can include vents between some or all of the fins which can increase the heat sinking and allow for easier placement of the fins and angles of the finds.

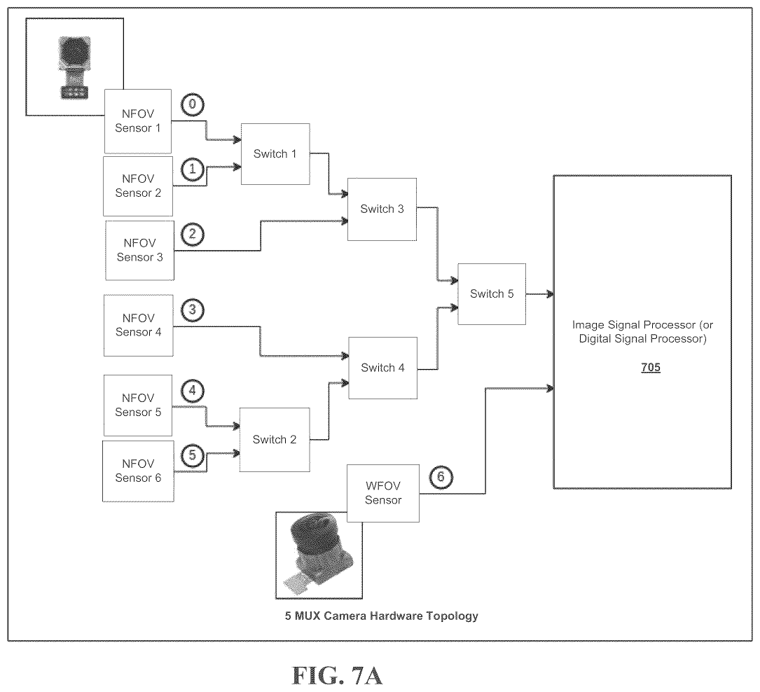

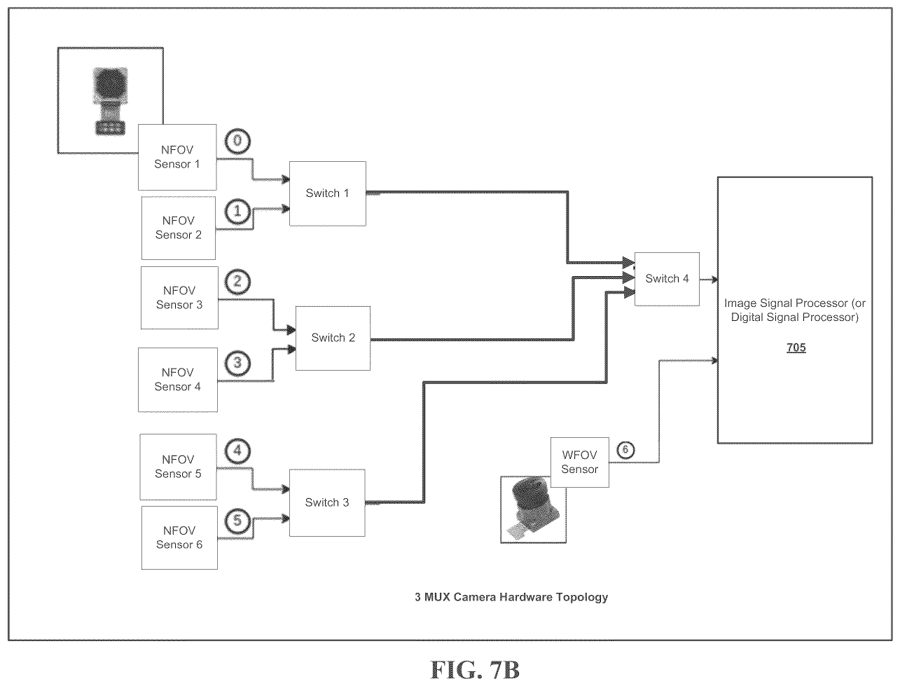

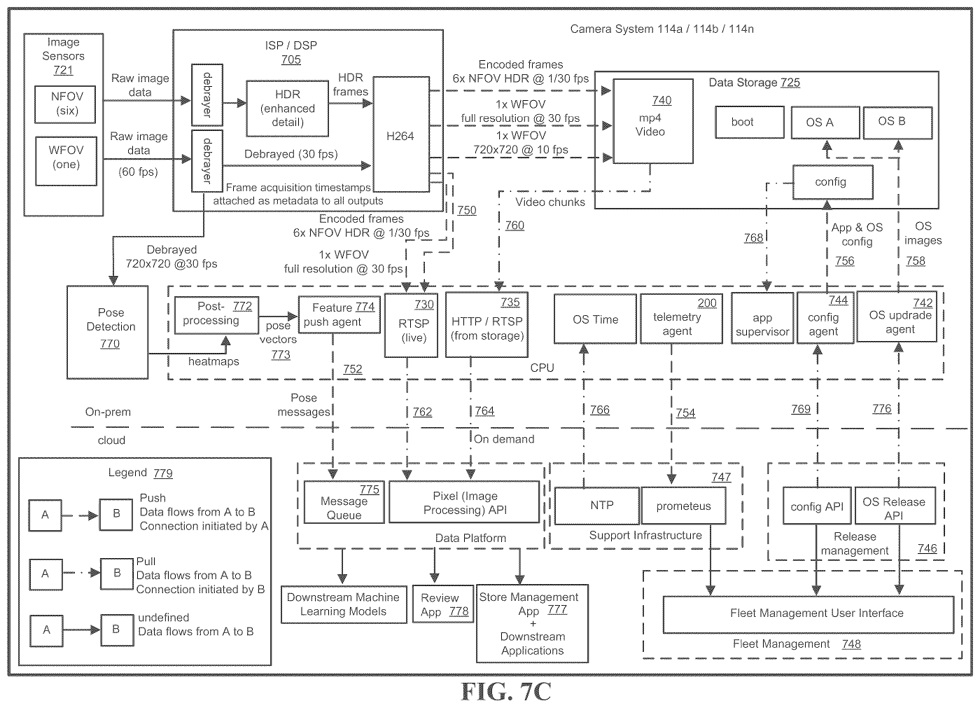

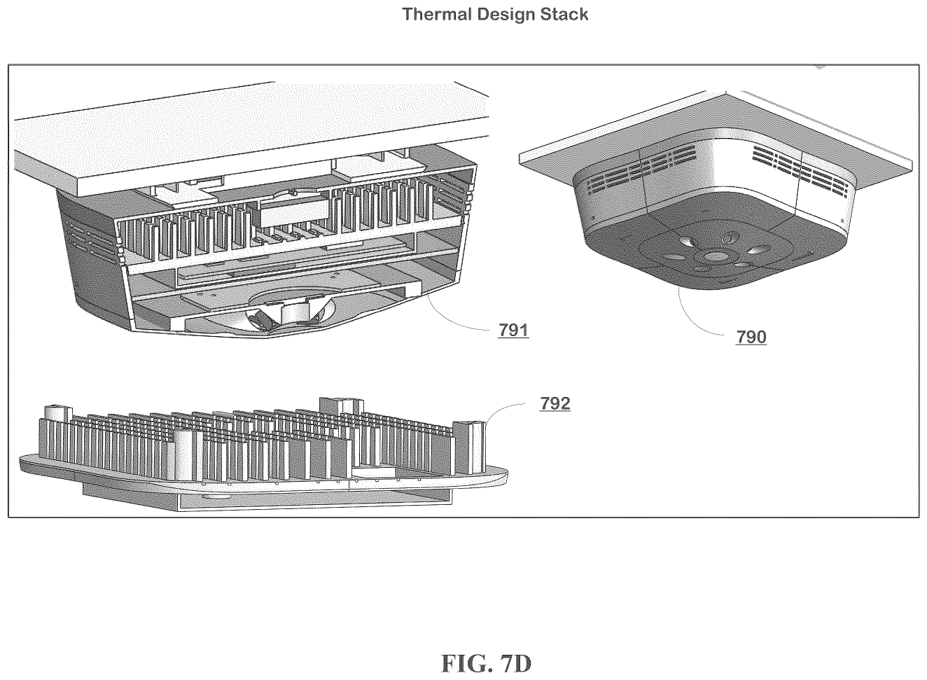

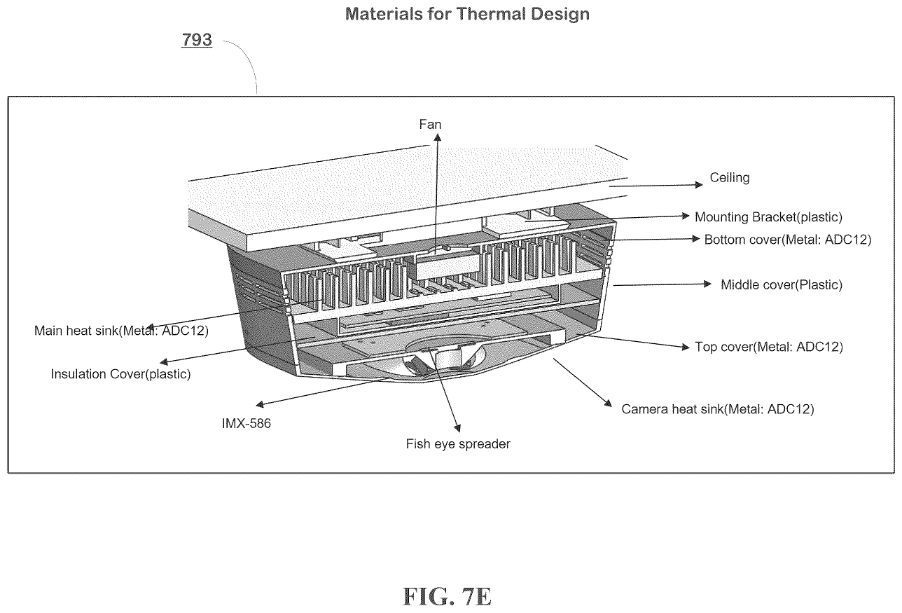

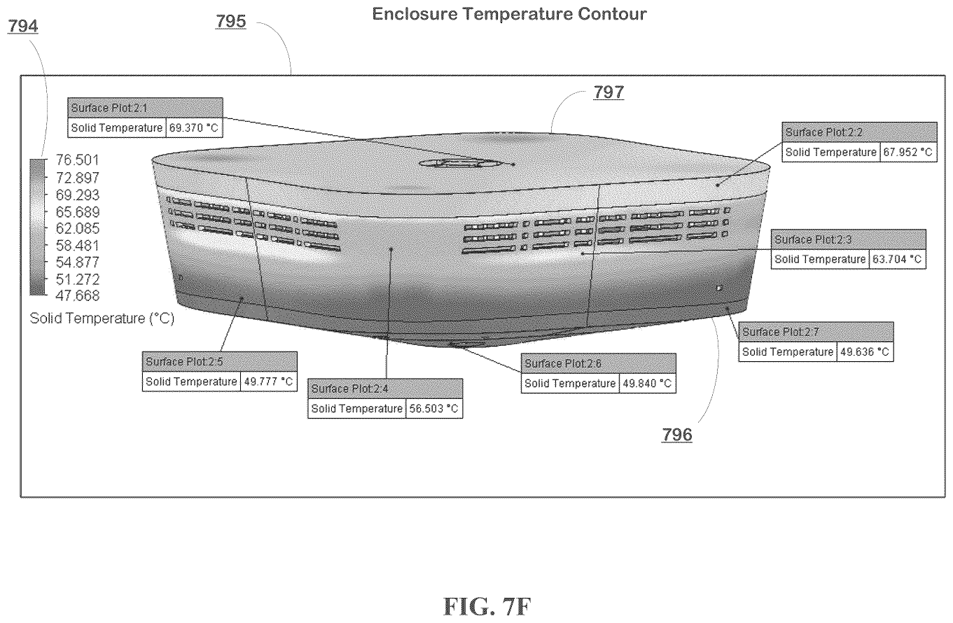

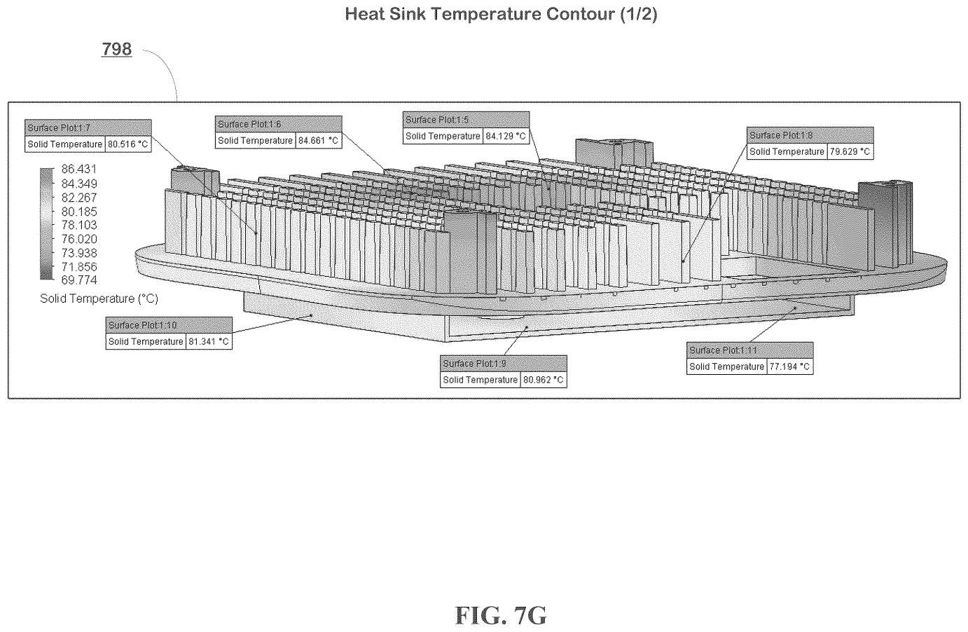

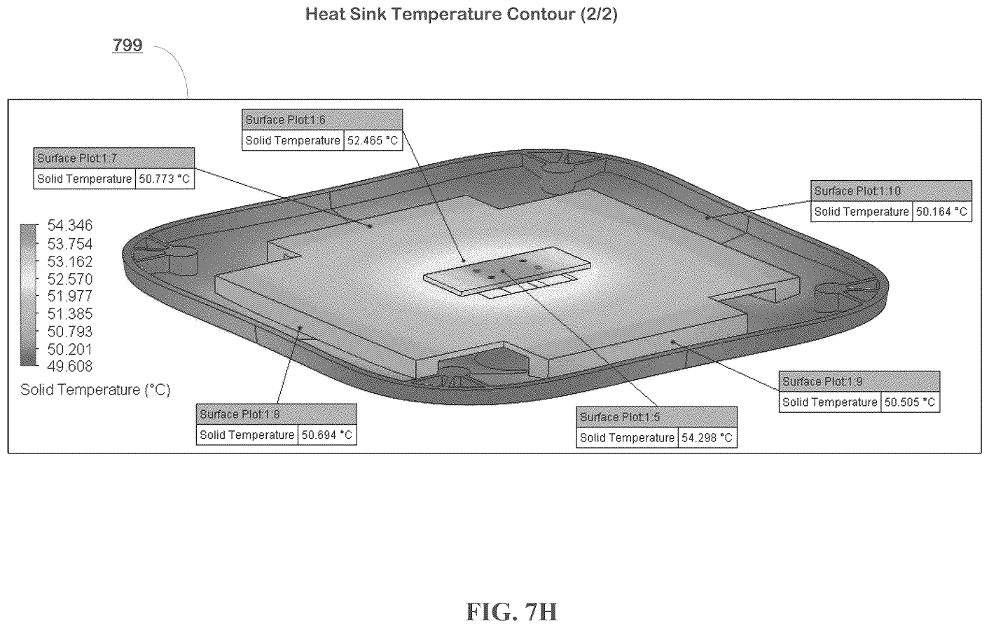

FIGS. 7A and 7B provide two example camera hardware topologies that can be used to process data from six NFOV sensors and one WFOV sensor for detecting events, identifying items in respective events and identifying and tracking subjects in the area of real space. An image signal processor (also referred to as a digital signal processor or DSP) can have an upper bandwidth limit related to the amount of image data that it can process per unit time. As the camera system can include a plurality of cameras (or sensors), the raw image data captured by the cameras per unit time can be more than the processing capacity (or the bandwidth) of the image signal processor (ISP; also referred to as digital signal processor). Various ISPs (or DSPs) can have their respective input bandwidth limits identifying the maximum number of raw image pixels that can be processed by the respective ISP per second. For example, a CV5S88 ISP can process 960 MPS (mega pixels per second). The technology disclosed uses various camera hardware topologies such as a 5-MUX scheme (shown in FIG. 7A) and 3-MUX scheme (shown in FIG. 7B) to limit the raw pixel data input to the ISP such that input pixel data does not exceed the bandwidth limit of the ISP. These two camera hardware topologies (3 MUX and 5 MUX) are shown as examples. It is understood that the technology disclosed can use other techniques and other camera hardware topologies to limit the amount of raw image data input to the ISP per unit time.

In one implementation, the technology disclosed can use a round robin algorithm or round robin technique such that raw image data from one or more selected sensors (or cameras) is sent to the image signal processor (or digital signal processor) for a predetermined time duration. The ISP can process this raw image data during that predetermined time. After the predetermined time duration, the switching scheme connects one or more other sensors to the ISP for the predetermined time duration. The technology disclosed can therefore, implement such a round robin technique in which the cameras are connected to the ISP (or DSP) for a predetermined time duration at their respective turn. The technology disclosed can also include memory buffers that can store raw image data from sensors or cameras. The ISP can then access the buffer of a sensor when the corresponding sensor is connected through the switch to the ISP. In one implementation, each sensor is connected to the ISP for a twenty second time duration in the round robin algorithm. In another implementation, each sensor is connected to the ISP for a thirty second time duration in the round robin algorithm. It is understood that pre-determined time duration less than twenty seconds and greater than thirty seconds, up to forty seconds, forty-five seconds or more can be used in the round robin algorithm.

FIG. 7A presents the 5-MUX camera hardware topology in which six NFOV sensors (labeled as sensor 1, sensor 2, sensor 3, sensor 4, sensor 5 and sensor 6) are connected to the image signal processor (or digital signal processor) via five switches (labeled as switch 1, switch 2, switch 3, switch 4, switch 5). A WFOV sensor is also connected to the image signal processor (ISP) 705. Switch 1 is used to select between raw image data from NFOV sensor 1 and NFOV sensor 2. Switch 2 is used to select between raw image data from NFOV sensor 5 and NFOV sensor 6. Switch 3 is used to select between the output from switch 1 (from either sensor 1 or sensor 2) and the raw image data from NFOV sensor 3. Switch 4 is used to select between the output from switch 2 (from either sensor 4 or sensor 5) and the raw image data from NFOV sensor 4. Switch 5 can be used to select between the outputs from switch 3 and switch 4. The 5-MUX network topology offers the advantage of loading the ISP memory with less raw image data and can achieve the functionality desired with just one available video input port on the ISP. However, the 5-MUX design can increase the complexity of the network topology and interconnections due to increase in the number of components required as compared to other topologies such as 3-MUX camera topology. As described above, the raw image data from a selected sensor is sent to the ISP for processing for a pre-determined time such as thirty seconds. During this time, the raw image data from other sensors is not sent to the ISP. In one implementation, the sensors that are not connected to the ISP using the switching scheme for the pre-determined duration send raw image data to respective memory buffers. The ISP can then access respective memory buffers of sensors in a round robin manner to access raw image data and process the raw image data one-by-one, such that image data related to a same time period from each sensor can be accessed for subsequent processing.

FIG. 7B presents the 3-MUX camera hardware topology in which six NFOV sensors (labeled as sensor 1, sensor 2, sensor 3, sensor 4, sensor 5 and sensor 6) are connected to the image signal processor (or digital signal processor) via three switches (labeled as switch 1, switch 2, switch 3). A WFOV sensor is also connected to the image signal processor (ISP). Switch 1 is used to select between raw image data from NFOV sensor 1 and raw image data from NFOV sensor 2. Switch 2 is used to select between raw image data from NFOV sensor 3 and raw image data from NFOV sensor 4. Switch 3 is used to select between raw image data from NFOV sensor 5 and raw image data from NFOV sensor 6. A selection switch 4 can be used to select one of the outputs from switch 1, switch 2 and switch 3 for input to the ISP (705). A WFOV sensor is also connected to the ISP (705). The 3-MUX camera hardware topology requires three available video input ports in the ISP and may also require more memory to operate as an architecture. The advantage of 3-MUX camera hardware topology is that there are fewer signal integrity issues, printed circuit board (PCB) layout and routing complexity is also reduced as compared to 5-MUX camera hardware topology. The 3-MUX camera hardware topology may require more cost of memory and more development time to bring up the ISP to operate these many simultaneous input channels of data.

FIG. 7C presents an architecture of the camera systems 114a. Other camera systems installed in the area of real space (such as camera system 114b and camera system 114n) may also have similar architecture. The camera system can comprise an image sensor assembly 721 comprising at least one or more of NFOV image sensors and at least one or more WFOV image sensors. In one implementation, the camera system can include six NFOV image sensors as shown in the image sensors assembly 721. The camera system can include from two to twenty or more NFOV image sensors. In one implementation, the camera system can include one WFOV sensor as shown in the image sensor assembly 721. The camera system can include more than one WFOV image sensor, such as two, three or more WFOV image sensors. Raw image data from image sensors is sent to the ISP (705) using one of the two camera hardware topologies such as 3-MUX and 5-MUX. In other implementations, other types of camera hardware topologies can be used to connect image sensors to ISP for sending image data for processing. The ISP 705 (also referred to as DSP) processes raw image data from the sensors and generates encoded image frames for sending to the data storage 725 at different frame rates. For example, the raw image data from WFOV image sensor can be encoded at thirty frames per second (or 30 fps). The raw image data from the WFOV image sensor can also be encoded at lower image frame rates such as ten frames per second (10 fps). Other image frame rates greater than 30 fps or lower than ten (10) fps can be used as well. Different frame capture rates can be used for NFOV image sensors. ISPs (or DSPs) receive raw image data as captured by image sensors (such as NFOV image sensors and WFOV image sensors) and process them to output video signals that can be used by downstream devices and processes. ISPs can perform various operations such as resolving colors (also referred to as debayering), combining image frames to achieve HDR (high-dynamic range) images and encode the signals into various codecs (such as H264, H265, etc.). ISPs reduce the size of the raw image to data so that the volume of data is manageable for storing, streaming and inputting to downstream processes and devices. The image stream from one or more WFOV image sensors can be used for identifying events and for identifying and tracking subjects in the area of real space. The WFOV image data stream can guide the item identification process (or product recognition process). The WFOV image stream can be used to detect the events in the area of real space such as takes, puts, touches of items. The events detected can then trigger the product or item detection or recognition process. The WFOV image stream has faster frame rates but lower resolution as compared to NFOV image stream that can have slower frame rates but higher image resolution. The high-resolution frames from NFOV sensors can be used to reliably detect even small items on shelves due to their high image resolution. The image stream from one or move NFOV image sensors can be used for detecting items in the area of real space. In one implementation, the technology disclosed can combine the NFOV image stream and the WFOV image stream when generating a video for storing in the data storage (such as in MP4 video format) or for streaming to downstream devices and processes.

As described above, the camera system can use a round robin algorithm to process raw image data captured by NFOV sensors one-by-one for a pre-determined time duration. For example, in one implementation, raw image data from each NFOV sensor is processed for thirty-second time durations in a round robin manner. If there are six NFOV sensors, each NFOV sensor's raw image data is processed after about three minutes for a thirty-second time duration per image sensor. In one implementation, the camera system produces one good quality image frame from the raw image data captured by each NFOV sensor in a thirty second time period for further processing. Therefore, in this case, the ISP (705) produces encoded image frames per NFOV sensor at a rate of 1/30 frames per second. In other implementations, the NFOV sensors may produce image frames at frame rates greater than or less than 1/30 frames per second. When the processing is switched to a selected NFOV image sensor at its turn in the round robin algorithm, certain sensors or camera parameters have to be adjusted or set for the NFOV sensor such as white balance, etc. When a NFOV image sensor is selected in the round robin algorithm, the ISP pipeline for that sensor has to be restarted and re-adjusted for white balance, exposure, focus before a usable frame from the NFOV image sensor is processed for downstream processes.

The NFOV and WFOV image frames can be streamed using a live streaming device 730. The live streaming device may implement a real time streaming protocol (RTSP) to send image frames from NFOV sensors and WFOV sensor to other devices on the camera system 114a, or to other camera systems 114b, 114n or to other on-premise processing devices in the area of real space. The NFOV and WFOV image frames can also be live streamed to a cloud-based server for other processes such as for use in shopping store management system (or store management app 777) that allows employees of the shopping store or store management to review operations of the shopping store and respond to the needs of the shoppers. Other downstream applications or downstream processes can also access the live stream of image frames from NFOV and WFOV sensors. For example, a review application (or review app 778) can use live streamed image frames to review the actions performed by subjects (such as shoppers) to verify items taken by the subjects. The shopping store management systems can use live streaming of image frames to detect any anomalies in the area of real space such as medical emergencies, fallen items on floors, spills, empty shelf spaces, shoppers needing help from store staff, security threats, congestion in a particular area of the store, etc. The streams of NFOV and WFOV image frames can be live streamed to machine learning models that are trained to detect events, items, subjects or other types of anomaly or security situations as described above. Notifications for store employees, store managers, security staff, local police department, local fire department, etc. can be generated automatically based on outputs of these models. In some cases, notifications can be sent to cell phone devices of checked-in shoppers in the area of real space to inform them about any emergency situation that may require their attention. Segments of video (740) captured by NFOV sensors and WFOV sensors can be stored in the data storage 725. These video segments can be made available, on demand, to other devices and/or processes in the camera system or on cloud-based server via an on-demand streaming device 735 that can communicate to external systems using a Hypertext Transfer Protocol (HTTP), Hypertext Transfer Protocol Secure (HTTPS) or any other data transfer or communication protocol. The date storage 725 can store one or more operating systems and/or firmware and various configuration parameters to support operations of the camera system. The camera system can comprise operating system upgrade agent (742) and configuration agent (744) that can connect via a release management component 746 to external systems (such as a fleet management system 748) to receive updates to configuration parameters and/or operating systems. The camera system can comprise a telemetry agent (200) that can communicate to the fleet management system 748 via a support infrastructure component (747) to provide values of camera system's operational parameters to the fleet management system. The fleet management system can generate alarms and/or notifications when values of one or more parameters of the camera system are outside a pre-determined range. For example, if the temperature of the camera system rises above a desired level, the fleet management system can notify the maintenance team to check the health of the camera system. The fleet management system can also generate notifications for the maintenance team for periodic maintenance of the camera system. The fleet management system 748 includes logic to determine which firmware and/or software is to be deployed on camera systems in the area of real space. Different firmware/software may be deployed to different camera systems within the same area of real space depending upon the hardware (such as image sensors, ISP, etc.) deployed on the camera system. Different camera systems may also run different software applications, machine learning models, and/or edge compute applications, etc.

The various components and/or devices of the camera system 114a include logic to either push or pull data when required. For example, data flows labeled as 750, 752, 754, 756 and 758 indicate data that is pushed from the source component and/or device to the destination component and/or device. The data flows labeled as 760, 762, 764, 766, 768, 769 and 776 indicate data that is pulled by the destination component from the source component. A legend 779 illustrates the various types of line patterns to represent different types of data flows in FIG. 7C.

Raw image data from sensors can be processed by a pose detection device 770 that includes logic to generate poses of subjects that are in the field of view of the WFOV sensor. The output from the pose detection device 770 is sent to a post-processing device 772 that can extract pose vectors corresponding to subjects detected by the pose detection device. The pose vectors (773) are sent to a feature push agent (774) that can push pose messages to a message queue device 775. The message queue device 775 can send the pose vectors as part of pose messages to one or more machine learning models for identifying subjects and/or tracking subjects. In one implementation, trained machine learning models are deployed on the camera system to identify subjects and track subjects. In such an implementation, the camera system may also receive pose vectors for subjects from other camera systems with overlapping fields of view to generate three-dimensional models of subjects. The camera systems can share image frames, pose vectors or other data with other camera systems in the area of real space.

In one implementation, the camera system includes logic to identify events, identify subjects and/or track subjects in the area of real space. In such an implementation, the raw image data captured by the WFOV image sensor or image frames generated from raw image data captured by WFOV image sensor is not sent to cloud-based server or other systems outside the camera system for processing to identify events, identify subjects and/or track subjects. In such an implementation, the raw image data captured by the WFOV image sensor or the image frames generated from the raw image data captured by the WFOV image sensor may only be sent out to cloud-based server or other external system during installation process when image sensors are being installed in the area of real space, e.g., to calibrate the image sensors. In the implementation, in which subject detection and subject tracking is performed on the camera system, the cloud-based server or another external system may send a global state of the area of real space including the subjects that are identified and being tracked in the area of real space. The global state can identify locations of subjects in the area of real space and their respective identifiers so that the camera system can match the subject to one of the existing subjects being tracked by the shopping store. The identification may require matching the subject identified in the current time interval to the same subject identified in one of the earlier time intervals. Note that these identifiers are internally generated identifiers to track subjects during their stay in the area of real space and are not linked to subjects' accounts or another type of real-world identifier. Additionally, as the subjects may move across a large area of space that is large enough to span across fields of view of several WFOV image sensors, identifying and tracking a subject may require tracking information from multiple WFOV sensors. The camera system may also communicate with other camera systems directly or via a server (such as the cloud-based server) to access subject identification and tracking data.

The technology disclosed anonymously tracks subjects without using any personally identifying information (PII). The technology disclosed can perform the subject identification and subject tracking operations using anonymous subject tracking data related to subjects in the area of real space as no personal identifying information (PII), facial recognition data or biometric information about the subject may be collected or stored. The subjects can be tracked by identifying their respective joints over a period of time as described herein. Other non-biometric identifiers such as the color of a shirt or a color of hair, etc., can be used to disambiguate subjects who are positioned close to each other. The technology disclosed does not use biometric data of subjects or other personal identification information (PII) to identify and/or track subjects. The technology disclosed does not store biometric or PII data to preserve privacy of subjects including shoppers and employees. Examples of personally identifying information (PII) include features detected from face recognition, iris scanning, fingerprints scanning, voice recognition and/or by detecting other such identification features. Even though PII may not be used, the system can still identify subjects in a manner so as to track and predict their paths in an area of real space. The technology disclosed does not store biometric or PII data to preserve privacy of subjects including shoppers and/or employees. If the subject has checked in to the store app, the technology disclosed can use certain information such as gender, age range, etc. when providing targeted promotions to the subjects if such data is voluntarily provided by the subject when registering for the app.

In one implementation, the camera system includes logic to generate crops (i.e., small portions) of images from image frames generated using raw image data captured by the WFOV image sensor. The image crops are provided to machine learning models that are running within the camera system and/or outside the camera system such as on a cloud-based server. The image crops can be sent to review processes running outside the camera system for identifying events, identifying and/or verifying items taken by subjects. The review process can also be conducted for any other reasons such as security review, threat detection and evaluation, theft and loss prevention, etc.

In one implementation, the event identification, subject identification and/or subject tracking is implemented on a cloud-based server. In such an implementation, the raw image data captured by the WFOV image sensor is sent to a cloud-based server for identifying subjects and/or tracking subjects.

In one implementation, the item detection logic is implemented in the camera system. In such an implementation, the raw image data captured by NFOV image sensors and/or the image frames generated using the raw image data captured by NFOV image sensors is not sent to any systems outside the camera system such as to cloud-based server, etc. In another implementation, in which the item detection logic is implemented is implemented on a cloud-based server or on a system outside the camera system, the raw image data captured by NFOV image sensors and/or the image frames generated using the raw image data captured by NFOV image sensors can be sent to the cloud-based server and/or the external systems implementing the logic to detect items related to the detected events.

In one implementation, detecting events in the area of real space is implemented using an “interaction model”. The interaction model can be implemented using a variety of machine learning models. A trained interaction model can take an input of at least one image frame or a sequence of image frames that are captured prior to the occurrence of the event and after the occurrence of the event. For example, if the event occurred at a time t1, then ten image frames prior to t1 and ten image frames after t1 can be provided as input to the interaction model to detect whether an event occurred or not. In other implementations, more than ten image frames can be used prior to the time t1 and after the time t1 such as twenty, thirty, forty or fifty image frames to detect an event. The event can include taking of an item by a shopper, putting an item on a shelf by a shopper or an employee, touching an item on the shelf, rotating or moving the item on the shelf, etc. In the implementation, in which the event is detected by logic implemented on a server outside the camera system, a message can be sent back to the camera system including the data about the event such as event type, location of the event in the area of real space, time of the event, camera identifier, etc. The camera system can then access the NFOV image sensor with a field of view in which the event occurred to get image frames and/or raw image data to detect items related to the event. The camera system can access the buffer and/or the storage in which the NFOV image sensor's raw image data or image frames are stored to access the frame related to the detected event for item identification.

FIGS. 7D to 7G present camera system design for efficient heat dissipation through the sensor assembly housing and from other devices and components placed in the camera system housing. It is desirable to maintain a temperature of less than sixty (60) degrees Celsius for operations of the sensors or cameras. Further, it is desirable to minimize vent spaces for security purposes, to reduce moisture ingress to avoid condensation issues, and to improve the aesthetics of the product. The top side of the enclosure faces the floor of the area of real space when the camera system is installed on the ceiling. It is desirable to minimize the size of the camera system enclosure to allow installation of camera systems with minimum disruption to existing installations (such as lighting, air-conditioning and heating vents, etc.).

FIG. 7D presents an example thermal design stack for the camera system. An example enclosure design 790 is shown as installed on a ceiling. An illustration 791 shows a cross-section of the enclosure design. A heat sink design including fins for dissipating heat is also shown (792).

FIG. 7E presents an illustration 793 indicating various materials that can be used for constructing various parts of the camera system enclosure.

FIG. 7F presents an illustration 795 showing a temperature contour for the camera system enclosure. A legend 794 maps temperature values (in degrees Celsius) to colors. The highest temperature range is shown in red color while the lowest temperature range is shown in blue color. The top part of the enclosure (796) is relatively cold and therefore rendered in blue color while the bottom part of the enclosure (797) is relatively hot and therefore rendered in orange and red colors.

FIG. 7G presents a heat sink temperature contour (798) rendered in various colors. The central portion is rendered in red color indicating higher temperature of the sink while out portions are rendered in yellow and blue colors indicating lower temperature on the outside regions of the heat sink.

FIG. 7H presents temperature contour (799) of top cover of camera system enclosure rendered in various colors. The highest temperature (rendered in red color) is around the central part of the cover. The temperature profile decreases as distance from the center increases. Outer portions are rendered in blue color indicating lower temperatures.

### Network Configuration

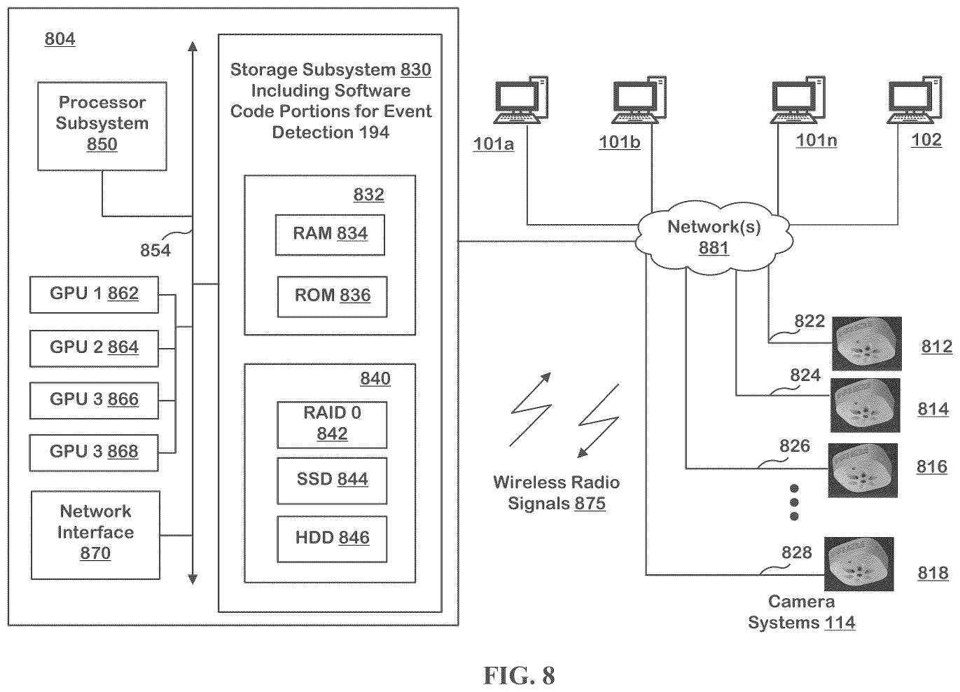

FIG. 8 presents the architecture of a network including a network node (or computer system) 804. The system includes a plurality of network nodes 101a, 101b, 101n, and 102 in the illustrated implementation. In such an implementation, the network nodes are also referred to as processing platforms. Processing platforms (network nodes) 101a, 101b, 101n, 102, 104, 106 and camera systems (114) including 812, 814, 816, . . . , 818 are connected to network(s) 881.

FIG. 8 shows a plurality of camera systems 812, 814, 816, . . . , 818 connected to the network(s). A large number of cameras can be deployed in particular systems. In one implementation, the camera systems 812 to 818 are connected to the network(s) 881 using Ethernet-based connectors 822, 824, 826, and 828, respectively. In such an implementation, the Ethernet-based connectors have a data transfer speed of 1 gigabit per second, also referred to as Gigabit Ethernet. It is understood that in other implementations, camera systems 114 are connected to the network using other types of network connections which can have a faster or slower data transfer rate than Gigabit Ethernet. Also, in alternative implementations, a set of cameras can be connected directly to each processing platform, and the processing platforms can be coupled to a network.

Storage subsystem 830 stores the basic programming and data constructs that provide the functionality of certain implementations of the technology disclosed. For example, the various modules implementing the functionality of the event detection and classification engine 194 may be stored in storage subsystem 830. The storage subsystem 830 is an example of a computer readable memory comprising a non-transitory data storage medium, having computer instructions stored in the memory executable by a computer to perform all or any combination of the data processing and image processing functions described herein including logic to track subjects, logic to detect inventory events, logic to predict paths of new subjects in a shopping store, logic to predict impact on movements of shoppers in the shopping store when locations of shelves or shelf sections are changed, logic to determine locations of tracked subjects represented in the images, logic match the tracked subjects with user accounts by identifying locations of mobile computing devices executing client applications in the area of real space by processes as described herein. In other examples, the computer instructions can be stored in other types of memory, including portable memory that comprise a non-transitory data storage medium or media, readable by a computer.

These software modules are generally executed by a processor subsystem 850. A host memory subsystem 832 typically includes a number of memories including a main random access memory (RAM) 834 for storage of instructions and data during program execution and a read-only memory (ROM) 836 in which fixed instructions are stored. In one implementation, the RAM 834 is used as a buffer for storing re-identification vectors generated by the event detection and classification engine 194.

A file storage subsystem 840 provides persistent storage for program and data files. In an example implementation, the file storage subsystem 840 includes four 120 Gigabyte (GB) solid state disks (SSD) in a RAID 0 (redundant array of independent disks) arrangement, as identified by reference element 842. In the example implementation, maps data in the planogram database 140, item data in the items database 150, store maps in the store map database 160, camera placement data in the camera placement database 170, camograms database 180 and video/image data in the video/image database 190 which is not in RAM, is stored in RAID 0. In the example implementation, the hard disk drive (HDD) 846 is slower in access speed than the RAID 0 (842) storage. The solid state disk (SSD) 844 contains the operating system and related files for the event detection and classification engine 194.

In an example configuration, four cameras 812, 814, 816, 818, are connected to the processing platform (network node) 804. Each camera has a dedicated graphics processing unit GPU 1 862, GPU 2 864, GPU 3 866, and GPU 4 868, to process images sent by the camera. It is understood that fewer than or more than three cameras can be connected per processing platform. Accordingly, fewer or more GPUs are configured in the network node so that each camera has a dedicated GPU for processing the image frames received from the camera. The processor subsystem 850, the storage subsystem 830 and the GPUs 862, 864, 866 and 868 communicate using the bus subsystem 854.

A network interface subsystem 870 is connected to the bus subsystem 854 forming part of the processing platform (network node) 804. Network interface subsystem 870 provides an interface to outside networks, including an interface to corresponding interface devices in other computer systems. The network interface subsystem 870 allows the processing platform to communicate over the network either by using cables (or wires) or wirelessly. The wireless radio signals 875 emitted by the mobile computing devices in the area of real space are received (via the wireless access points) by the network interface subsystem 870 for processing by an account matching engine. A number of peripheral devices such as user interface output devices and user interface input devices are also connected to the bus subsystem 854 forming part of the processing platform (network node) 804. These subsystems and devices are intentionally not shown in FIG. 8 to improve the clarity of the description. Although bus subsystem 854 is shown schematically as a single bus, alternative implementations of the bus subsystem may use multiple busses.

In one implementation, the camera systems 114 can be comprise a plurality of NFOV image sensors and at least one WFOV image sensor. Various types of image sensors (or cameras) such can be used such as Chameleon3 1.3 MP Color USB3 Vision (Sony ICX445), having a resolution of 1288×964, a frame rate of 30 FPS, and at 1.3 MegaPixels per image, with Varifocal Lens having a working distance (mm) of 300-∞, a field of view field of view with a ⅓” sensor of 98.2°-23.8°. The cameras 114 can be any of Pan-Tilt-Zoom cameras, 360-degree cameras, and/or combinations thereof that can be installed in the real space.

### Experimental Results

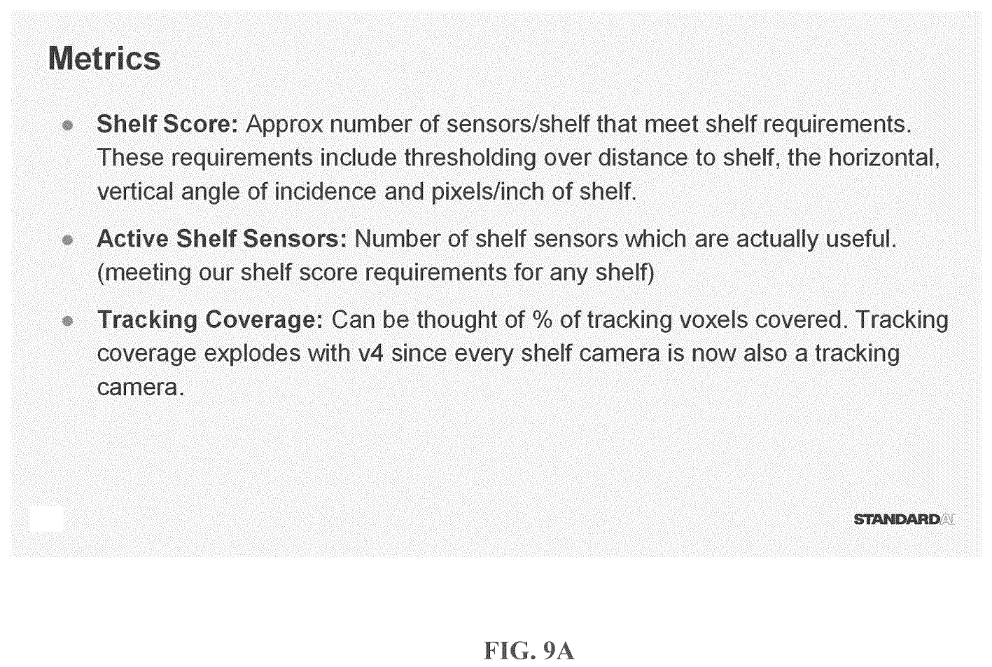

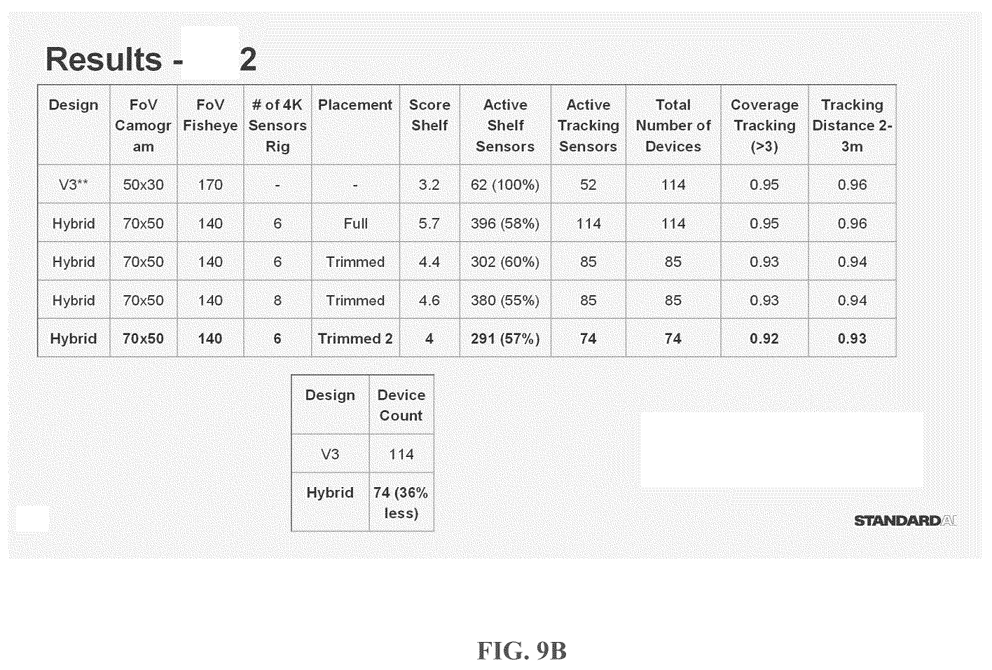

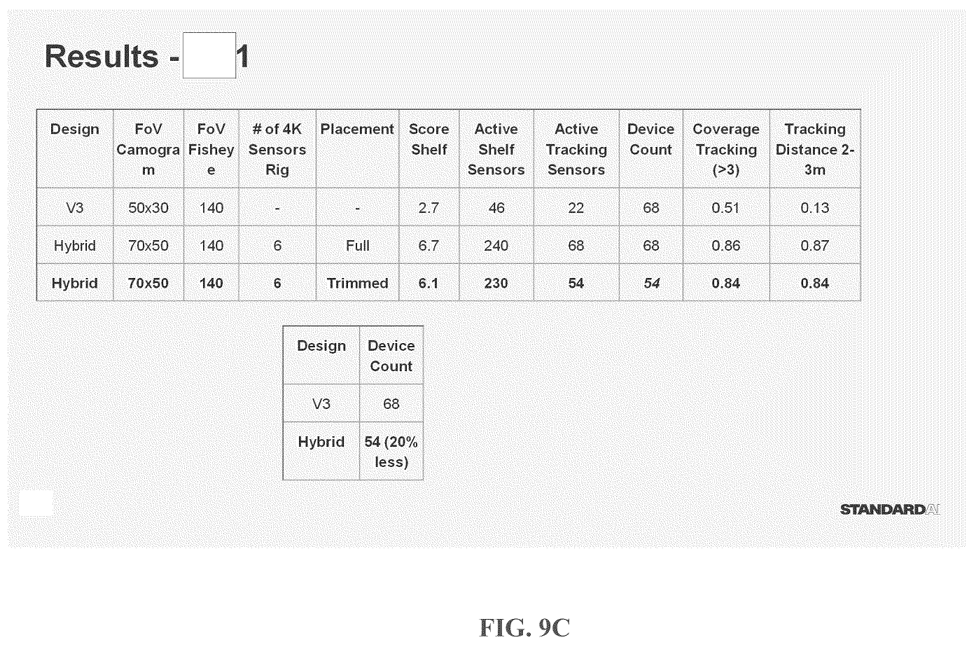

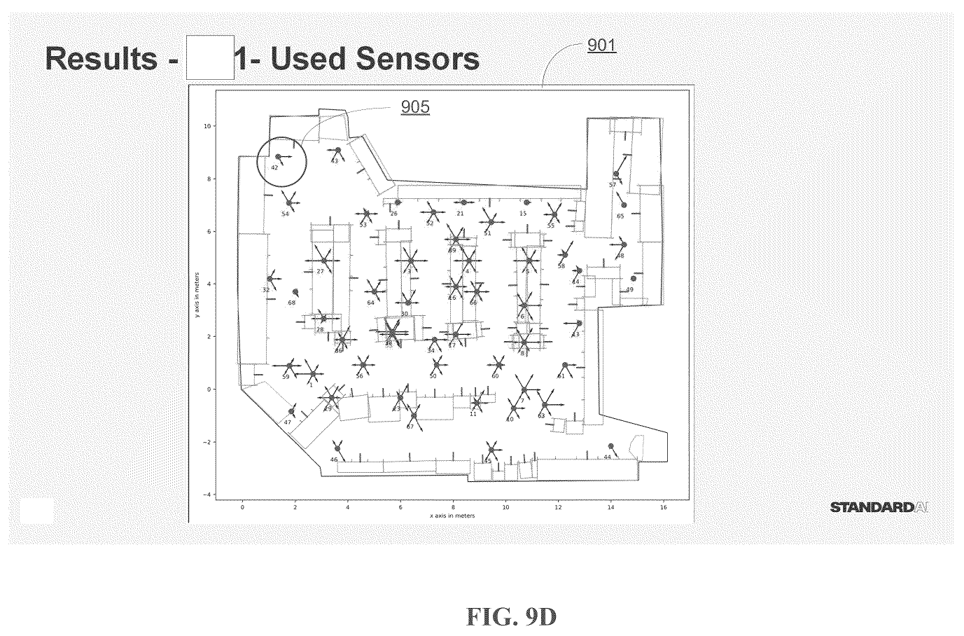

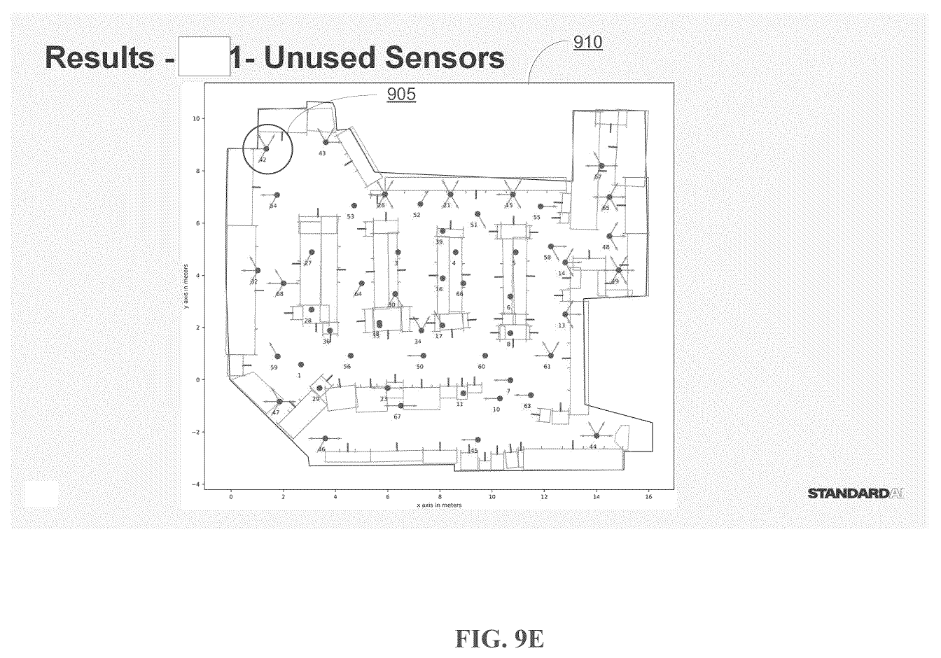

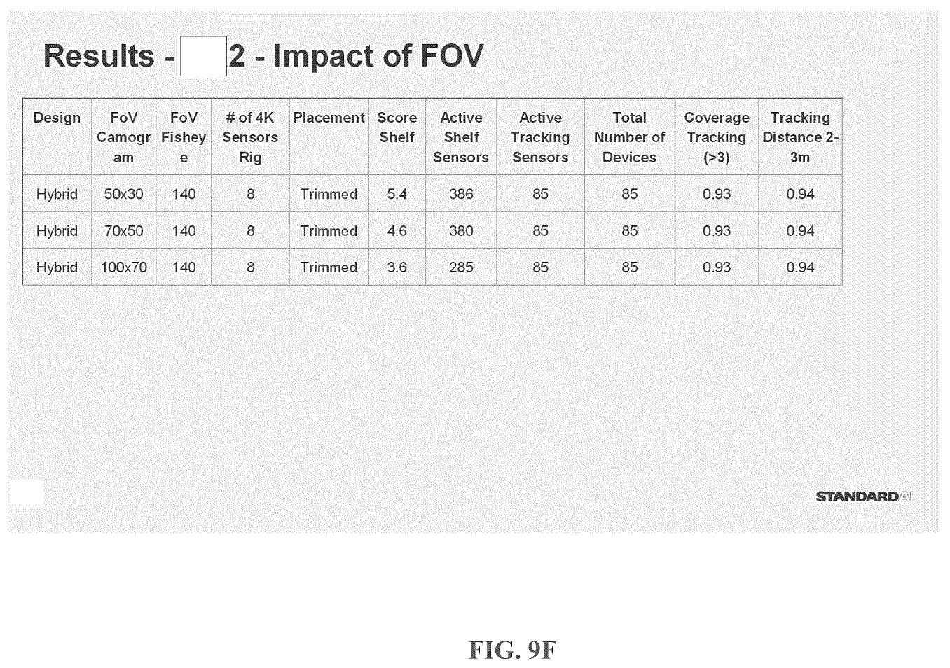

FIGS. 9A to 9F presents various metrics and experimental results using camera system.

FIG. 9A presents various types of metrics that have been considered when designing the camera system. The metrics such as shelf score, active shelf sensors and tracking coverage allow evaluation of the camera system design so that it is effective in detecting events in the area of real space, identifying items related to events and identifying and tracking subjects in the area of real space.

FIGS. 9B and 9C present test results for various camera system designs. The test results in FIGS. 9B and 9C are arranged in tables that present the test results as arranged in the following columns. Each row (except for the first row) in the table presents results of a particular camera system in an area of real space. A “design” column presents the name of camera system design used in the test. A “FOV camogram” column presents the field of view values for the one or more NFOV sensors in the camera system. The NFOV sensors are used for identifying items on shelves, therefore, they are also referred to as camogram cameras or camogram sensors. A “FOV fisheye” column presents the field of view values for the one or more WFOV cameras or WFOV sensors in the camera system. A “placement” column indicates whether all NFOV sensors (or camogram cameras) in the camera system are used for identifying. When all NFOV sensors are used for identifying items then it is referred to as “full” mode (or full camera system mode). When selected NFOV sensors are used and/or turned on for identifying items then this is referred to as “trimmed” mode (or partial camera system mode). A “shelf score” or “score shelf” column presents shelf score for the experiment. The shelf score is defined in FIG. 9A and indicates the approximate number of sensors per shelf that meet the shelf requirements or shelf coverage requirements. The requirements include thresholding over distance to shelf, the horizontal and vertical angle of incidence and pixels per inch of shelf A column labeled “active shelf sensors” is defined in FIG. 9A. The value of “active shelf sensors” indicates the number of NFOV sensors per shelf that are useful for identifying items. This metric indicates the number of NFOV sensors per shelf that meet the shelf score requirement as described above. A column labeled “active tracking sensors” indicates the number of fisheye (or WFOV) sensors or WFOV cameras that are used for tracking subjects. A column labeled “total number of devices” indicates the total number of sensors that are used in the area of real space. The metric includes all WFOV (or fisheye) and NFOV (or camogram) cameras or sensors that are used in the experiment. A column labeled “coverage tracking (>3)” indicates how much of the entire area of real space is covered by at least three more sensors. In one implementation, this metric is calculated for coverage using WFOV sensors. In another implementation, this metric is calculated for coverage using NFOV sensors. A column labeled “tracking distance 2-3m” indicates cameras or sensors that are at a distance of two to three meters from the “neck” area of the subjects. In one implementation, neck joints of subjects are used for tracking. A neck joint is typically at a distance of 1.5 meters from the floor.

FIG. 9B presents test results for various designs of the camera system including scores for the columns as described above. Row number one (excluding the heading row) presents test results for camera system design, “V3”. This camera system design includes both fisheye or WFOV cameras (for subject tracking) and 4K rectilinear lens cameras for camograms to identify items. Row number 2 (excluding the heading row) presents test results for a “hybrid” camera system design. A “hybrid” camera system design can include at least one fisheye (or WFOV) sensor and six or eight camogram (or NFOV) sensors. This camera system provides a field of view of 70 degrees by 50 degrees (for NFOV sensors or camogram sensors) and 140 degrees for WFOV sensors (or fisheye sensors). This experiment was conducted with six NFOV sensors with full placement of cameras i.e., all six camogram (or NFOV) sensors are used in the experiment for identifying items. Row number three 3 (excluding the heading row) presents test results for a “hybrid” camera system design in which the camogram sensors (or NFOV) sensors have a field of view of 70 degrees by 50 degrees, the WFOV sensors have a field of view of 140 degrees. The experiment included use of six NFOV sensors. The experiment was conducted in a trimmed mode i.e., only few of the NFOV sensors per camera system were used for identifying items. The sensors (or cameras) that are facing the shelves are used and the ones that are not facing the shelves are turned off. Row number 4 (excluding the heading row) presents test results for a “hybrid” camera system design in which the NFOV sensors have a field of view of 70 degrees by 50 degrees, the WFOV sensors have a field of view of 140 degrees. The camera system includes eight NFOV (or camogram) sensors per camera system. The experiment is conducted using trimmed mode, i.e., only some of the camogram sensors per camera system are used for identifying items on shelves. Row number 5 (excluding the heading row) presents test results for a “hybrid” camera system design in which the NFOV (or camogram) sensors have a field of view of 70 degrees by 50 degrees, the WFOV (or fisheye) sensors have a field of view of 140 degrees. The camera system includes six NFOV sensors per camera system. The experiment is conducted in a “trimmed 2” mode, i.e., only selected NFOV sensors from each camera system are used for identifying items on shelves. The “trimmed 2” mode a minimalistic setting where the bare minimum or least number of sensors are used per camera system for identifying items. Therefore, this experiment shows used the least number of sensors i.e., “74”.

FIG. 9C presents test results for various designs of the camera system including scores for the columns as described above. Three experiments were conducted. The second row (excluding the heading row) shows highest shelf score “6.7” with “full” mode of operations of the camera system i.e., all sensors per camera system are used. The third row (excluding the heading row) shows a relatively good shelf score of “6.1” is achieved with “hybrid” design and with “trimmed” mode. This experiment shows that least number of camera devices, i.e., fifty four (54) were used to achieve this shelf score.

FIGS. 9D and 9E present placement of cameras in an area of real space for one of the experiments presented above. The camera placement in FIGS. 9D and 9E relates to the experiment presented in row number three of test results in FIG. 9B. FIGS. 9D and 9E show placement of camera system on a map of the area of real space. The area of real space represents a shopping store with shelves for displaying items. A circle (or a dot) in illustrations (901 in FIG. 9D and 910 in FIG. 9E) represents a camera system with one or more WFOV images sensors and six NFOV image sensors. An outward arrow from the circle indicates a field of view of a NFOV image sensor. The arrows in FIG. 9D (map 901) illustrate the NFOV image sensors from which image streams are being used for identifying items. Note that camera systems that are positioned away from boundary of the area of real space, use more NFOV image sensors (in some cases all six image sensors are used). The camera systems that are positioned close to boundaries of the area of real space may only use a few of the NFOV image sensors. This is because the image sensors that are pointed towards the walls (or the boundary) are not used. For example, a camera system 905 in FIG. 9D uses only two NFOV sensors for identifying items. This camera system is positioned such that a wall is positioned on two sides (top and left) of the camera system as shown in the map 901 of the area of real space (i.e., a shopping store). Two NFOV image sensors in camera system 905 that have their fields of view towards right-side are being used for identifying items. The sensors or cameras that are not used can be turned off selectively per camera system.

FIG. 9E presents the map 910 in which the NFOV image sensors in the camera systems that are not being used for identifying items are shown. The map 910 shows the same area of real space with the same camera system placement as shown in the map 901 in FIG. 9D. In the map 910, the four unused sensors of the camera 905 are shown as arrows. Note that these sensors have their respective fields of view towards the two walls of the shopping store and therefore, the image streams from these four sensors are not used by the camera system for identifying items. The number of camera systems placed in an area of real space depends on the size of the area of real space and complexity of the space such as the number of shelves and/or other inventory display structures. The area of real space shown in FIGS. 9D and 9E has an area of about 160 square meters. This area of real space can be covered by around sixty to seventy camera systems. A single camera system can cover about twenty to thirty square feet or about two to three square meters of area. When more shelves are placed in the area of real space, higher number of NFOV camera coverage may be needed to identify items placed on shelves. For subject tracking and event detection, fewer WFOV cameras may be needed. For example, for subject tracking, one WFOV camera per sixty square feet (about five square meters) to one hundred square feet (about nine square meters) may be sufficient. It is understood that above-mentioned estimates are based on currently available cameras and/or image sensors. As camera/sensor technology evolves, fewer cameras/sensors may be needed for subject tracking, event detection and/or item identification.

FIG. 9F presents test results for various designs of the camera system to show how fields of view of sensors can impact the number of sensors required in the area of real space. It can be seen in the table in FIG. 9F that as the fields of view of sensors increase, fewer active sensors are needed to achieve a desired shelf coverage and subject tracking targets.

Any data structures and code described or referenced above are stored according to many implementations in computer readable memory, which comprises a non-transitory computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein. The scope of the technology disclosed is defined by the appended claims.

1. A camera system for detecting events and identifying items in detected events in an area of real space in a shopping store including a cashier-less checkout system, the camera system comprising:
an image sensor assembly comprising at least one narrow field of view (NFOV) image sensor and at least one wide field of view (WFOV) image sensor, the at least one NFOV image sensor producing raw image data of first-resolution frames of a corresponding field of view in the real space and the at least one WFOV image sensor producing raw image data of second-resolution frames of a corresponding field of view in the real space;
logic to provide at least a portion of a sequence of second-resolution frames produced by the WFOV image sensor to an event detection device configured to detect (i) a particular event and (ii) a location of the particular event in the area of real space; and
logic to send at least one frame in the sequence of first-resolution frames to an item detection device configured to identify a particular item in the particular event detected by the event detection device.

2. The camera system of claim 1, further comprising logic to send the portion of the second-resolution frames to a subject tracking device configured to identify a subject using at least one image frame from the portion of the second-resolution frames.

3. The camera system of claim 1, wherein the image sensor assembly comprises at least two or more NFOV image sensors.

4. The camera system of claim 3, further comprising logic to provide the location at which the particular event is detected to a sensor selection device to select a sequence of the first-resolution frames provided by a NFOV image sensor by matching the location in the area of real space to the corresponding field of view of the NFOV image sensor.

5. The camera system of claim 3, further comprising:
logic to operate the NFOV image sensors in a round robin manner, turning on a NFOV image sensor for a pre-determined time period and turning off remaining NFOV image sensors to collect the raw image data from the turned on NFOV image sensor; and
logic to provide the raw image data collected from the turned on NFOV image sensor to an image processing device configured to generate a sequence of first-resolution frames corresponding to the turned on NFOV image sensor.

6. The camera system of claim 3, further comprising:
a memory storing the raw image data produced by the NFOV image sensors;
logic to access the raw image data produced by the NFOV sensors and stored in the memory in a round robin manner to collect raw image data from at least one NFOV image sensor; and
logic to provide the raw image data collected from the least one NFOV image sensor to an image processing device configured to generate the sequence of first-resolution frames corresponding to the at least one NFOV image sensor.

7. The camera system of claim 3, further comprising:
logic to store the first-resolution frames and the second resolution frames in a storage device; and
logic to access the storage device to retrieve a set of frames from a particular sequence of first-resolution frames in dependence upon a signal received from a data processing device and logic to provide the retrieved set of frames to the data processing device for downstream data processing.

8. The camera system of claim 1, wherein the first-resolution is higher than the second-resolution.

9. The camera system of claim 1, wherein the NFOV image sensor is configured to output at least one frame per a pre-determined time period.

10. The camera system of claim 9, wherein the pre-determined time period is between twenty seconds and forty seconds.

11. The camera system of claim 1, wherein the second-resolution frames have an image resolution of at least 3,040 pixels by at least 3,040 pixels.

12. The camera system of claim 1, further comprising:
logic to stream the first-resolution frames and the second resolution frames to a data processing device configured to process the first-resolution frames and the second-resolution frames and detect inventory events and identify items corresponding to the inventory events.

13. The camera system of claim 1, further comprising a pose detection device comprising:
logic to receive a portion of the second-resolution frames from the wide field of view sensor;
logic to extract features from the portion of the second-resolution frames, wherein the features represent joints of a subject in the corresponding field of view of the WFOV image sensor; and
logic to provide the extracted features to a subject tracking device configured to identify a subject in the area of real space using at least one of the extracted features.

14. The camera system of claim 1, further comprising logic to provide operation parameters of the NFOV image sensor and the WFOV image sensor to a telemetry device configured to generate a notification when the operation parameters of at least one of the NFOV image sensor and the WFOV image sensor is outside a desired range of operation parameters.

15. A method for detecting events and identifying items in detected events in an area of real space in a shopping store, the method including:
producing raw image data of first-resolution frames of a corresponding field of view in the real space using at least one NFOV image sensor and producing raw image data of second-resolution frames of a corresponding field of view in the real space using at least one WFOV image sensor;
detecting (i) a particular event and (ii) a location of the particular event in the area of real space using at least a portion of a sequence of second-resolution frames produced by the WFOV image sensor; and
identifying a particular item in the detected particular event by using at least one frame in the sequence of first-resolution frames.

16. The method of claim 15, further including identifying a subject using at least one image frame from the portion of the second-resolution frames using the portion of the second-resolution frames.

17. The method of claim 15, further including, producing raw image data of a plurality of sequences of first-resolution frames of corresponding fields of view in real space using at least two or more NFOV image sensors.

18. A non-transitory computer readable storage medium impressed with computer program instructions to detect events and identify items in detected events in an area of real space in a shopping store, the instructions, when executed on a processor, implement a method comprising:
producing raw image data of first-resolution frames of a corresponding field of view in the real space using at least one NFOV image sensor and producing raw image data of second-resolution frames of a corresponding field of view in the real space using at least one WFOV image sensor;
detecting (i) a particular event and (ii) a location of the particular event in the area of real space using at least a portion of a sequence of second-resolution frames produced by the WFOV image sensor; and
identifying a particular item in the detected particular event by using at least one frame in the sequence of first-resolution frames.

19. The non-transitory computer readable storage medium of claim 18, implementing the method further including, identifying a subject using at least one image frame from the portion of the second-resolution frames using the portion of the second-resolution frames.

20. The non-transitory computer readable storage medium of claim 18, implementing the method further including, producing raw image data of a plurality of sequences of first-resolution frames of corresponding fields of view in real space using at least two or more NFOV image sensors.
